(19) United States
(12) Patent Application Publication
(10) Pub. No.: US 2014/0020690 A1
(43) Pub. Date: Jan. 23, 2014

(54) ADJUSTABLE FOOT POSITIONING SYSTEM

(71) Applicant: IMDS Corporation, Providence, UT (US)

(72) Inventor: Daniel J. Triplett, Providence, UT (US)

(73) Assignee: IMDS Corporation, Providence, UT (US)

(21) Appl. No.: 13/948,010

(22) Filed: Jul. 22, 2013

Related U.S. Application Data
(60) Provisional application No. 61/674,210, filed on Jul. 20, 2012.

(51) Int. Cl. A61G 13/12

(52) U.S. Cl. CPC A61G 13/125; A61G 13/128
USPC 128/845

(57) ABSTRACT

A limb positioner apparatus includes a stabilizing plate and a movable positioning plate for arrangement about a joint or fracture. The movable plate is movable with respect to the stabilizing plate about three mutually perpendicular planes which intersect at a point corresponding to a center of rotation of the joint or fracture. The positioning plate may also be movable with respect to the stabilizing plate along at least one linear direction. At least some of the available degrees of freedom are selectively lockable. The apparatus is illustrated in the context of the foot and ankle. Methods of use are disclosed.

### CROSS-REFERENCE TO RELATED APPLICATIONS

This application is a non-provisional of:

pending U.S. Provisional Patent Application No. 61/674,210, filed Jul. 20, 2012, which carries Applicant's docket No. IMDS-2 PROV, and is entitled ADJUSTABLE FOOT POSITIONING SYSTEM.

The above-identified document is incorporated herein by reference.

### FIELD OF THE DISCLOSURE

This disclosure relates to apparatus and methods for supporting and positioning a limb, such as for therapeutic, surgical, orthopedic, or other purposes. The present disclosure is made in the context of apparatus and methods for supporting and positioning the lower leg, specifically the ankle and foot. However, this technology is applicable to other limbs and portions thereof, such as the knee, elbow, hand and wrist, to name a few examples.

In one application of the present technology, the disclosed apparatus may be employed to support and position a lower leg, ankle, and foot for the purpose of performing ankle surgery, such as ankle fusion or ankle arthroplasty.

### BACKGROUND OF THE INVENTION

The failure rate of therapeutic, surgical, orthopedic, or other medical procedures may be due at least in part to poor accuracy and precision in the techniques and/or instruments used in the procedure. For example, the failure rate of total ankle arthroplasty may be due to poor accuracy and precision in the surgical technique and associated instruments.

There is a need for a support and positioning apparatus that includes a limited or minimal number of components; is rigidly attachable to a support structure such as an examination, surgical, or operating table; fits into a standard size sterilization tray; fits into standard size sterilization chambers, such as autoclaves; replicates all joint motions or provides multiple degrees of freedom for fracture reduction; provides precise, accurate, individualized control of each degree of freedom; provides positive drive features for each degree of freedom; is easy to assemble; is intuitive to use; enables precise and accurate surgical procedures; and enables cleaning and/or sterilization without requiring complete disassembly to the component part level.

There is also a need for a positioning apparatus that can be placed flat on a support structure such as an examination, surgical, or operating table; requires no tools to operate; provides targeting means for the tibial intramedullary canal; and is compatible with laser targeting systems on external equipment such as fluoroscopy units, C-arms, and the like.

### BRIEF DESCRIPTION OF THE DRAWINGS

Various embodiments of the present technology will now be discussed with reference to the appended drawings. It is appreciated that these drawings depict only typical embodiments of the technology and are therefore not to be considered limiting of its scope.

FIG. 1 is an isometric view of a positioning apparatus coupled to the bones of a lower leg, ankle, and foot;

FIG. 2 is an isometric view of a base subassembly of the positioning apparatus of FIG. 1;

FIG. 3 is an isometric view of a first joint of the base subassembly of FIG. 2;

FIG. 4 is an isometric cross sectional view of the first joint of FIG. 3, taken along a mid-sagittal plane of the base subassembly;

FIG. 5 is an isometric view of a second joint of the base subassembly of FIG. 2;

FIG. 6 is an inferior cross sectional view of a portion of the second joint of FIG. 5;

FIG. 7 is an isometric cross sectional view of a portion of the second joint of FIG. 5, taken along a sagittal plane through the centerline of a drive shaft of the second joint;

FIG. 8 is an isometric cross sectional view of a portion of the second joint of FIG. 5, taken along a sagittal plane through the centerline of a locking mechanism shaft of the second joint;

FIG. 9 is an isometric view of a third joint of the base subassembly of FIG. 2;

FIG. 10 is an isometric cross sectional view of a portion of the third joint of FIG. 9, taken along a sagittal plane centered on a rail of the third joint;

FIG. 11A is an isometric detail view of a locking mechanism of the third joint of FIG. 9; and FIG. 11B is an isometric cross sectional view of a portion of the third joint of FIG. 9, taken along a transverse plane through the centerline of a locking mechanism shaft of the third joint;

FIG. 12 is a lateral detail view of a portion of the base subassembly of FIG. 2;

FIG. 13 is an oblique lateral detail view of a portion of the base subassembly of FIG.

FIG. 14 is an isometric view of a mounting post subassembly for use with the positioning apparatus of FIG. 1;

FIG. 15A is an isometric detail view of the base subassembly of FIG. 2 coupled to the mounting post subassembly of FIG. 14; and FIG. 15B is another isometric detail view of the base subassembly of FIG. 2 coupled to the mounting post subassembly of FIG. 14, from another viewpoint;

FIG. 16A is an isometric view of a foot plate subassembly of the positioning apparatus of FIG. 1; FIG. 16B is an isometric view of a portion of the foot plate subassembly of FIG. 16A; and FIG. 16C is another isometric view of a portion of the foot plate subassembly of FIG. 16A, from another viewpoint;

FIG. 17A is an isometric view of the base subassembly of FIG. 2 coupled to the foot plate subassembly of FIG. 16A; FIG. 17B is an isometric detail view of the base subassembly and foot plate subassembly of FIG. 17A; and FIG. 17C is another isometric detail view of the base subassembly and foot plate subassembly of FIG. 17A, from another viewpoint;

FIG. 18A is an isometric view of a fourth joint between the base subassembly and foot plate subassembly of FIG. 17A, the foot plate subassembly in a first position relative to the base subassembly; and FIG. 18B an isometric view of the fourth joint of FIG. 18A, the foot plate subassembly in a second position relative to the base subassembly;

FIG. 19A is an isometric detail view of the fourth joint of FIG. 18B; and FIG. 19B is an isometric cross sectional view of the fourth joint of FIG. 18B, taken along a sagittal plane centered on a rail of the fourth joint;

FIG. 20 is an isometric view of a tibial clamp subassembly of the positioning apparatus of FIG. 1;

FIG. 21A is an isometric view of the base subassembly and foot plate subassembly of FIG. 17A coupled to the tibial clamp subassembly of FIG. 20; FIG. 21B is an isometric detail view of a portion of the base subassembly, foot plate subassembly, and tibial clamp subassembly of FIG. 21A; FIG. 21C is an isometric detail view of a portion of the base subassembly, foot plate subassembly, and tibial clamp subassembly of FIG. 21A, coupled to a tibia and fibula; and

FIG. 21D is an isometric cross sectional detail view of a portion of the base subassembly, foot plate subassembly, tibial clamp subassembly, tibia, and fibula of FIG. 21A, taken along a sagittal plane through the centerline of a shaft of the tibial clamp subassembly;

FIG. 22 is a lateral view of the base subassembly, foot plate subassembly, and tibial clamp subassembly of FIG. 21A coupled to the bones of the lower leg, ankle, and foot;

FIG. 23 is an isometric view of the base subassembly, foot plate subassembly, tibial clamp subassembly, and bones of the lower leg, ankle, and foot of FIG. 22;

FIG. 24 is an anterior oblique detail view of a portion of the base subassembly, foot plate subassembly, tibial clamp subassembly, and bones of the lower leg, ankle, and foot of FIG. 22;

FIG. 25 is an anterior detail view of a portion of the base subassembly, foot plate subassembly, tibial clamp subassembly, and bones of the lower leg, ankle, and foot of FIG. 22;

FIG. 26 is a lateral view of the base subassembly, foot plate subassembly, tibial clamp subassembly, and bones of the lower leg, ankle, and foot of FIG. 22, with center of rotation targets attached to the base subassembly;

FIG. 27 is an isometric view of the base subassembly, center of rotation targets, foot plate subassembly, tibial clamp subassembly, and bones of the lower leg, ankle, and foot of FIG. 26;

FIG. 28A is an isometric view of the base subassembly, center of rotation targets, foot plate subassembly, tibial clamp subassembly, and bones of the lower leg, ankle, and foot of FIG. 26, with pins coupled to the center of rotation targets and extending toward the ankle center of rotation; and FIG. 28B is an isometric detail view of the base subassembly, center of rotation targets, pins, foot plate subassembly, tibial clamp subassembly, and bones of the lower leg, ankle, and foot of FIG. 28A;

FIG. 29A is an isometric detail view of the base subassembly, center of rotation targets, pins, foot plate subassembly, tibial clamp subassembly, and bones of the lower leg, ankle, and foot of FIG. 28; FIG. 29B is a medial view of the base subassembly, center of rotation targets, pins, foot plate subassembly, tibial clamp subassembly, and bones of the lower leg, ankle, and foot of FIG. 28; and FIG. 29C is an anterior view of the base subassembly, center of rotation targets, pins, foot plate subassembly, tibial clamp subassembly, and bones of the lower leg, ankle, and foot of FIG. 28;

FIG. 30 is a lateral view of the base subassembly, center of rotation targets, pins, foot plate subassembly, tibial clamp subassembly, and bones of the lower leg, ankle, and foot of FIG. 28, coupled to the mounting post subassembly of FIG. 14, with the foot and foot plate subassembly in extension;

FIG. 31 is a lateral view of the base subassembly, center of rotation targets, pins, foot plate subassembly, tibial clamp subassembly, and bones of the lower leg, ankle, and foot of FIG. 28, coupled to the mounting post subassembly of FIG. 14, with the foot and foot plate subassembly in flexion;

FIG. 32 is a lateral view of the base subassembly, center of rotation targets, pins, foot plate subassembly, tibial clamp subassembly, and bones of the lower leg, ankle, and foot of FIG. 28, coupled to the mounting post subassembly of FIG. 14, with tibial alignment guides coupled to the tibial clamp subassembly and the center of rotation targets;

FIG. 33 is an anterior view of the base subassembly, center of rotation targets, pins, foot plate subassembly, tibial clamp subassembly, tibial alignment guides, mounting post subassembly, and bones of the lower leg, ankle, and foot of FIG. 32;

FIG. 34 is an isometric view of the base subassembly, center of rotation targets, pins, foot plate subassembly, tibial clamp subassembly, tibial alignment guides, mounting post subassembly, and bones of the lower leg, ankle, and foot of FIG. 32;

FIG. 35 is an anterior view of the base subassembly, center of rotation targets, pins, foot plate subassembly, tibial clamp subassembly, tibial alignment guides, mounting post subassembly, and bones of the lower leg, ankle, and foot of FIG. 33, with the foot plate subassembly in a different position relative to the base subassembly;

FIG. 36 is an isometric detail view of the base subassembly, center of rotation targets, pins, foot plate subassembly, tibial clamp subassembly, tibial alignment guides, and bones of the lower leg, ankle, and foot of FIG. 32, with bone pins passing through the tibial clamp subassembly and into the bones of the lower leg;

FIG. 37 is an anterior view of the base subassembly, foot plate subassembly, tibial clamp subassembly, bone pins, and bones of the lower leg, ankle, and foot of FIG. 36;

FIG. 38 is a lateral view of the base subassembly, foot plate subassembly, tibial clamp subassembly, bone pins, and bones of the lower leg, ankle, and foot of FIG. 36;

FIG. 39 is an isometric view of another positioning apparatus;

FIG. 40 is an isometric detail view of a portion of the positioning apparatus of FIG. 39;

FIG. 41 is another isometric detail view of a portion of the positioning apparatus of FIG. 39, from a different viewpoint; and

FIG. 42 is another isometric detail view of a portion of the positioning apparatus of FIG. 39, from another viewpoint;

### DETAILED DESCRIPTION OF THE PREFERRED EMBODIMENTS

The present disclosure relates to apparatus and methods for supporting and positioning a limb, such as for therapeutic, surgical, orthopedic, or other purposes. Those of skill in the art will recognize that the following description is merely illustrative of the principles of the disclosure, which may be applied in various ways to provide many different alternative embodiments. This description is made for the purpose of illustrating the general principles of this invention and is not meant to limit the inventive concepts in the appended claims.

In this specification, standard medical directional terms are employed with their ordinary and customary meanings. Superior means toward the head. Inferior means away from the head. Anterior means toward the front. Posterior means toward the back. Medial means toward the midline, or plane of bilateral symmetry, of the body. Lateral means away from the midline of the body. Proximal means toward the trunk of the body. Distal means away from the trunk.

In this specification, a standard system of three mutually perpendicular reference planes is employed. A sagittal plane divides a body into bilaterally symmetric right and left portions. A coronal plane divides a body into anterior and posterior portions. A transverse plane divides a body into superior and inferior portions.

Apparatus

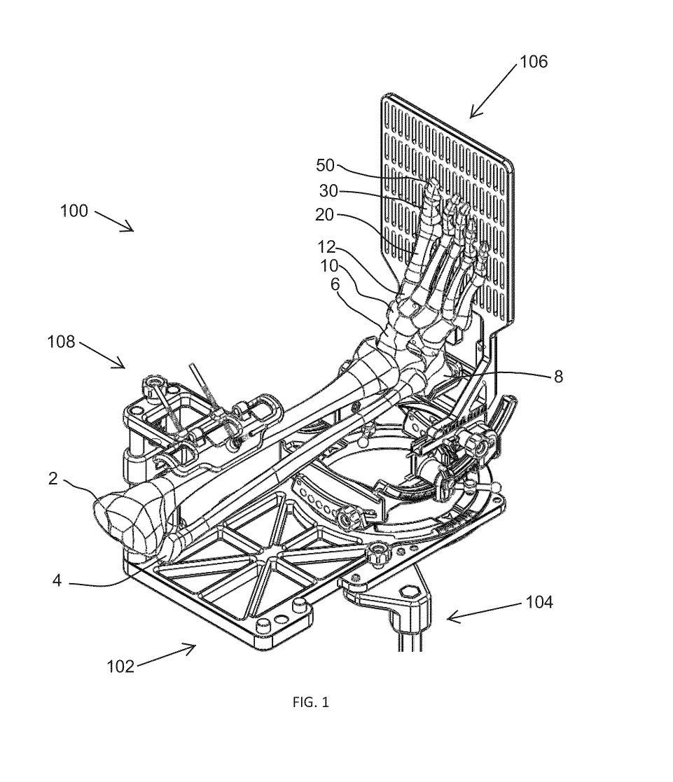

FIG. 1 is an isometric view of a positioning apparatus 100 coupled to bones of a lower leg, ankle, and foot. The positioning apparatus 100 includes a base subassembly 102, a mounting post subassembly 104, a foot plate subassembly 106, and a tibial clamp subassembly 108. Other subassemblies, accessories, or attachments may be included; some examples will be disclosed below. The lower leg bones include a tibia 2 and a fibula 4. The ankle and foot bones include a talus 6, a calcaneus 8, a navicular 10, a transverse cuneiform 12, a medial cuneiform 14, a lateral cuneiform 16, a cuboid 18, a first metatarsal 20, a second metatarsal 22, a third metatarsal 24, a fourth metatarsal 26, a fifth metatarsal 28, a first proximal phalanx 30, a second o proximal phalanx 32, a third proximal phalanx 34, a fourth proximal phalanx 36, a fifth proximal phalanx 38, a first middle phalanx 40, a second middle phalanx 42, a third middle phalanx 44, a fourth middle phalanx 46, a first distal phalanx 50, a second distal phalanx 52, a third distal phalanx 54, a fourth distal phalanx 56, and a fifth distal phalanx 58. Not all of these bones are labeled in FIG. 1 for clarity; unlabeled bones may be readily identified with reference to the labeled bones and a human anatomy text.

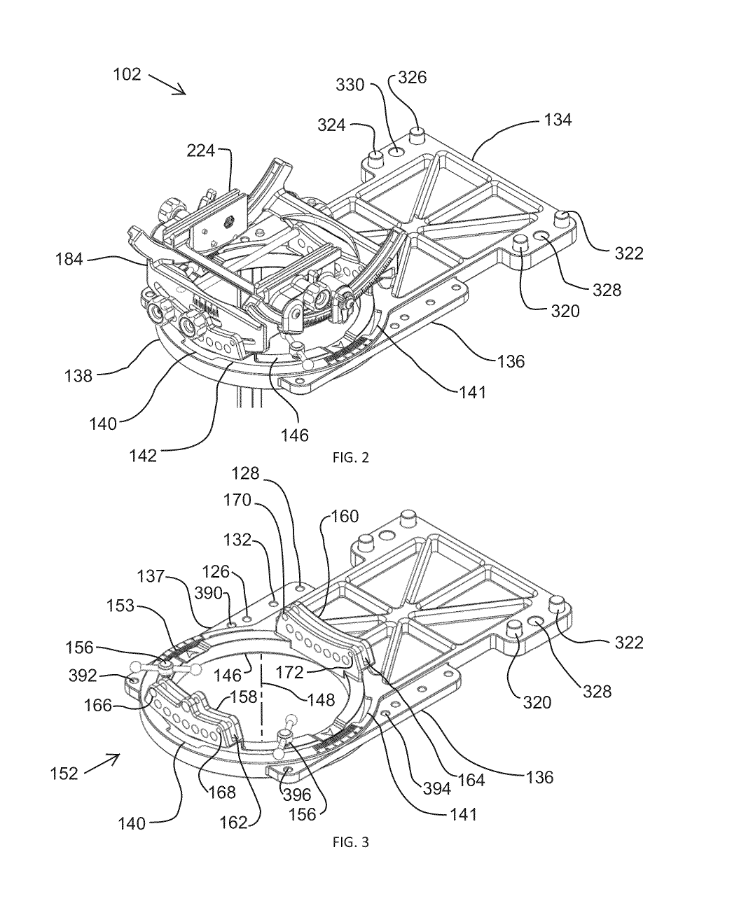

FIG. 2 is an isometric view of the base subassembly 102. The base subassembly 102 includes three rotational joints which rotate about three mutually perpendicular rotational axes. The base subassembly 102 need not be disassembled for cleaning, sterilization, or storage, in other words, the base subassembly 102 may be left intact and fully assembled for these actions. The base subassembly 102 includes a base plate 134, an inner ring 146, a gimbal 184, and a trolley 224. Some or all of these components may also be subassemblies.

The base plate 134 includes a rail 136 along a lateral side; bilateral rails 136, 137 are shown along each lateral side of the base plate 134. Each rail 136, 137 includes several hole patterns. For example, holes 126, 128, 132, which are used to couple the base subassembly 102 to the mounting post subassembly 104. The base plate 134 also includes protrusions 320, 322, 324, 326 and holes 328, 330, which are used to couple the base subassembly 102 to the tibial clamp subassembly 108. The base plate 134 also includes holes 390, 392, 394, 396 which are used to couple the base subassembly 102 to center of rotation targets. The base plate 134 may be considered as a foundation to which all other components in the positioning apparatus 100 are coupled. The base plate 134 includes an outer ring 138 between the rails 136, 137. The outer ring 138 includes a recess 140 in an inner wall 142 of the outer ring 138. Three recesses 139, 140, 141 are included in the example. The inner wall 142 also includes a circular groove 144.

FIG. 3 is an isometric view of a first joint 152 of the base subassembly 102. The first joint 152 provides a first degree of freedom of the positioning apparatus 100, which is rotation about an anterior-posterior axis 148. The axis 148 may also be described as the intersection of a sagittal plane and a transverse plane. The first joint 152 permits medial/lateral or varus/valgus flexing of the ankle.

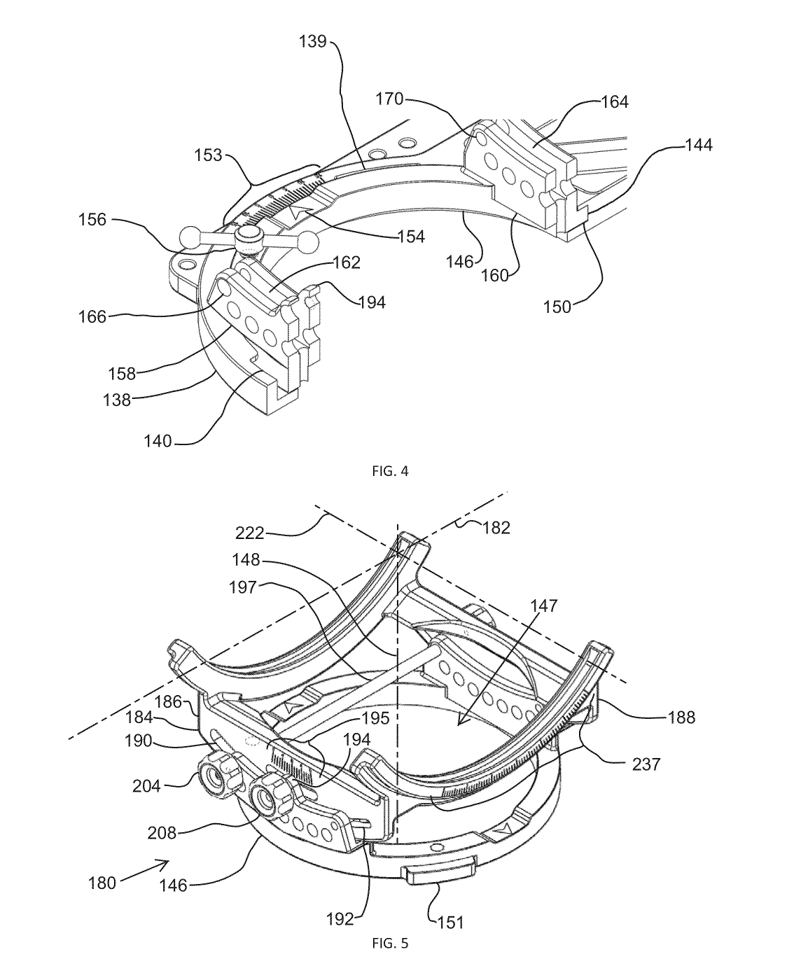

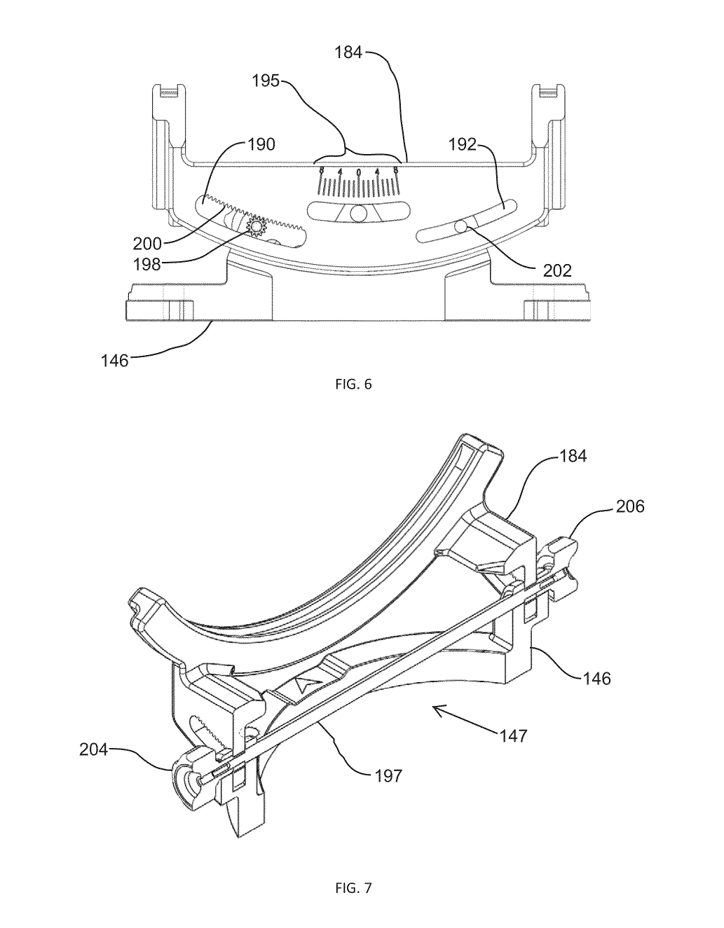

The first joint 152 includes the outer ring 138 of the base plate 134 and an inner ring 146 which is concentrically received in the outer ring 138. The first joint axis 148 extends along the common center points of the outer ring 138 and the inner ring 146. The inner ring 146 includes a peripheral lobe 150 or extension which engages one of the corresponding recesses 139, 140, 141 in the outer ring 138 to connect or disconnect the inner ring 146 from the base plate 134. The peripheral lobe 150 also engages the circular groove 144 so that the inner ring 146 concentrically rotates within the outer ring 138. Multiple lobes 149, 150, 151 may be included on the inner ring 146; the number and arrangement of lobes may correspond exactly to the number and arrangement of recesses. FIG. 4 is an isometric cross sectional view of the first joint 152, taken along a mid-sagittal plane of the base subassembly 102. The lobe 150 is visible, in engagement with the circular groove 144.

The example shown provides a total of 30 degrees of rotational adjustment, which may be represented as +/−15 degrees from a zero position. The zero position may also be referred to as an anatomically neutral position or a nominal position with respect to medial/lateral rotation. In other examples, rotational adjustment less than or greater than 30 degrees may be provided. Indicia 153, 154 may be provided on the outer ring 138 and inner ring 146 respectively to indicate the relative rotational position of the inner ring 146 with respect to the outer ring 138.

The first joint 152 may be moved or adjusted manually by rotating the inner ring 146 relative to the outer ring 138. Since the first joint 152 may be infrequently adjusted during a surgical procedure, the example shown lacks friction-reducing features, such as bushings or bearings. However, in other examples, friction-reducing features are contemplated in the first joint 152. The first joint 152 may be locked in a selected position by tightening one or more locking screws 156.

The inner ring 146 also includes a support 158, and may include bilateral supports 158, 160 diametrically opposed to one another. The support 158 includes an arcuate groove 162 and a mounting hole 166. Two mounting holes 166, 168 are shown in the support 158, one at each end of the support Likewise, the support 160 includes an arcuate groove 164 and a mounting hole 170, and may include a second mounting hole 172 as shown. The arcuate grooves 162, 164 may be defined by a common cylindrical surface which extends across the diameter of the inner ring 146, so that both grooves 162, 164 are coradial but spaced apart across the diameter of the inner ring 146.

FIG. 5 is an isometric view of a second joint 180 of the base subassembly 102. The second joint 180 provides a second degree of freedom of the positioning apparatus 100, which is rotation about a superior-inferior axis 182. The axis 182 may also be described as the intersection of a sagittal plane and a coronal plane. The second joint 180 permits axial rotation of the ankle about a longitudinal axis 182 of the tibia. The second joint axis 182 intersects the first joint axis 148. The second joint 180 may be useful in correcting anatomical abnormalities.

The second joint 180 includes the support 158 of the inner ring 146 and a gimbal 184 with a corresponding rail 186 which is received in the arcuate groove 162 of the support 158. In the example, bilateral rails 186, 188 are shown corresponding to the bilateral supports 158, 160. Each rail 186, 188 includes an arcuate slot 190, 194, respectively. Bilateral slots 190, 192, 194, 196 are included in the rails 186, 188 in the example. The slots 190, 192, 194, 196 may be defined by a common cylindrical surface which extends across the length of the gimbal 184, so that all slots 190, 192, 194, 196 are coradial, but slots 194, 196 are spaced apart across the length of the gimbal 184 from slots 190, 192. In this arrangement, the second joint 180 is symmetrically constructed across the operative site, in this case the ankle joint. Motion of the second joint 180 is constrained by shafts and/or pins engaging the mounting holes 166, 168, 170, 172 and extending through the arcuate slots 190, 192, 194, 196. In the example, a shaft 197 extends through mounting holes 166, 170 and arcuate slots 190, 194; a first pin 202 extends through mounting hole 168 and arcuate slot 192; and a second pin 203 extends through mounting hole 172 and arcuate slot 196. As the gimbal 184 moves relative to the inner ring 146, the shaft 197 rotates and the pins 202, 203 slide along the arcuate slots 190, 192, 194, 196. Second joint axis 182 extends along the common centers of the arcuate slots 190, 192, 194, 196; in other words, along the centerline of their common cylindrical surface.

The example shown provides a total of 16 degrees of rotational adjustment, which may be represented as +/−8 degrees from a zero position. The zero position may also be referred to as an anatomically neutral position or a nominal position with respect to rotation about the tibial axis. In other examples, rotational adjustment less than or greater than 16 degrees may be provided. Indicia 194, 195 may be provided on the inner ring 146 and the rails 186, 188 to indicate the relative rotational position of the gimbal 184 with respect to the inner ring 146.

The second joint 180 may be moved via a mechanism which drives both sides of the second joint 180 simultaneously using a drive shaft 197. A spur gear mechanism provides positive engagement with both sides of the second joint 180 to overcome potential friction. FIG. is an inferior cross sectional view of a portion of the second joint 180, taken along a transverse plane through arcuate groove 162. The spur gear 198 and corresponding rack teeth 200 are visible, as is a contralateral pin 202.

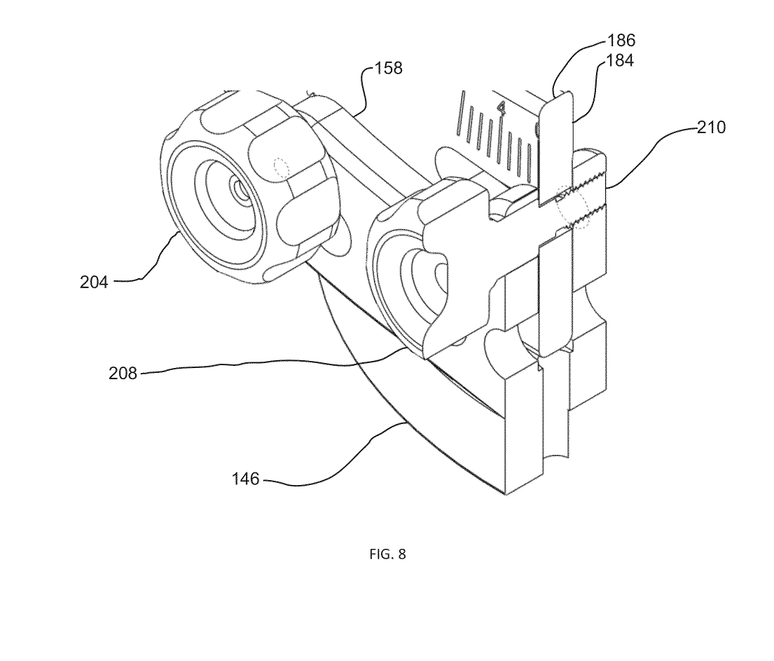

FIG. 7 is an isometric cross sectional view of a portion of the second joint 180, taken along a sagittal plane through the centerline of the drive shaft 197 of the second joint 180. In the example shown, the drive shaft 197 is situated within a visualization zone 147 around the operative site; in other words, the drive shaft 197 crosses an otherwise open central area 147 inside the inner ring 146. In another example, the drive shaft 197 may be located outside the visualization zone 147. A drive knob 204 may be used to turn the drive shaft to move the second joint 180. Bilateral drive knobs 204, 206 are shown in the example. One or both knobs may be used simultaneously. Since the second joint 180 may be infrequently adjusted during a surgical procedure, the example shown lacks additional friction-reducing features, such as bushings or bearings. However, in other examples, friction-reducing features are contemplated in the second joint 180. A thumbscrew 208 on one side of the second joint 180 may be used to lock out the second joint 180. An independent second thumbscrew may be provided on the other side of the second joint 180. FIG. 8 is an isometric cross sectional view of a portion of the second joint 180, taken along a sagittal plane through the centerline of a shaft 210 of the thumbscrew 208.

The gimbal 184 also includes an arcuate guide 212; the example shows a gimbal 184 with bilateral arcuate guides 212, 214. Each arcuate guide 212, 214 includes an arcuate groove 216, 218, respectively. The arcuate grooves 216, 218 may be defined by a common cylindrical surface which extends across the width of the gimbal 184, so that both grooves 216, 218 are coradial but spaced apart across the width of the gimbal 184.

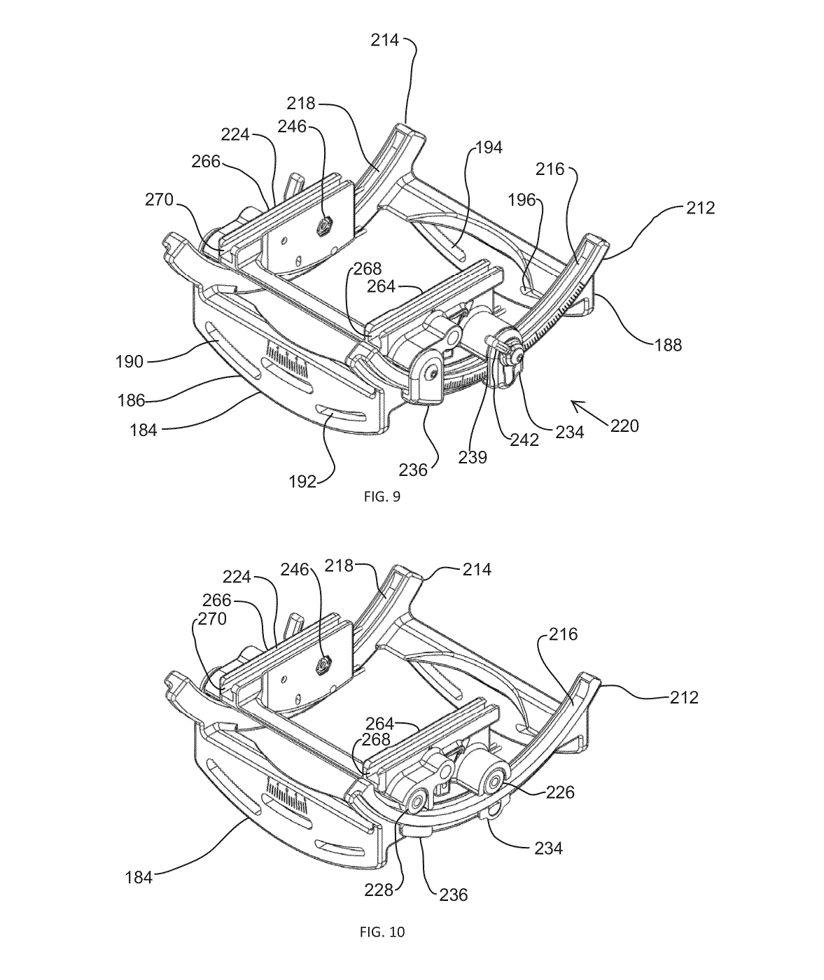

FIG. 9 is an isometric view of a third joint 220 of the base subassembly 102. The third joint 220 provides a third degree of freedom of the positioning apparatus 100, which is rotation about a medial-lateral axis 222. The axis 222 may also be described as the intersection of a coronal plane and a transverse plane. The third joint 220 permits flexion/extension motion of the ankle. The third joint axis 222 intersects the first joint axis 148 and the second joint axis 182, as shown in FIG. 5. The point at which the three axes 148, 182, 222 intersect may be referred to as the center of rotation of the positioning apparatus 100.

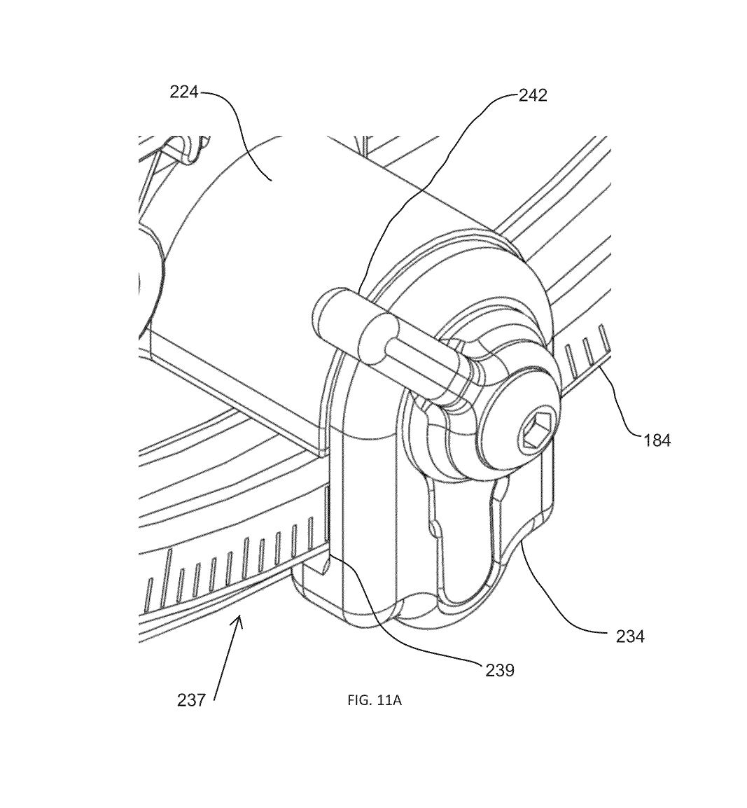

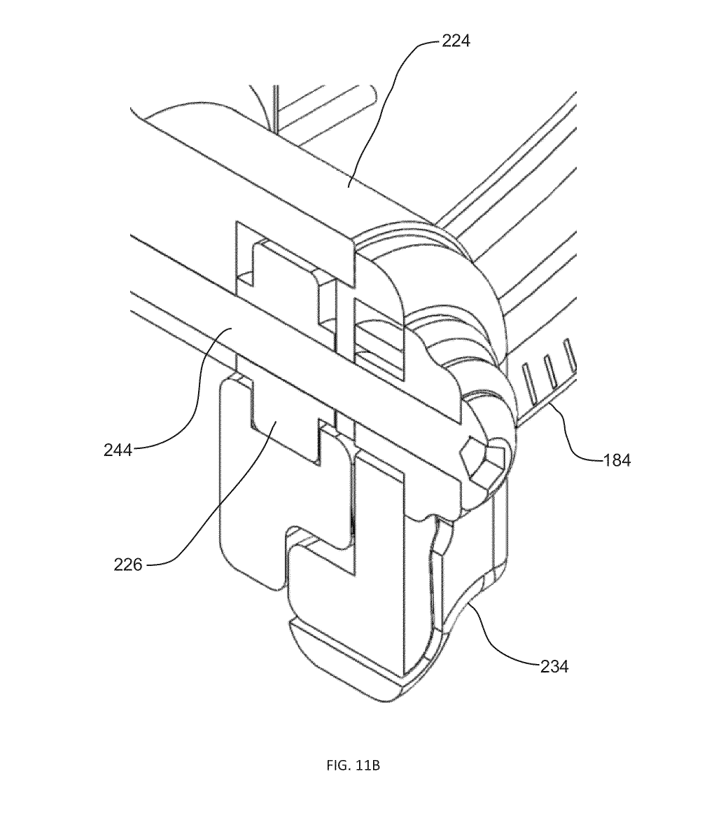

The third joint 220 includes the arcuate guide 212 of the gimbal 184 and a trolley 224 with a corresponding roller 226 engaged in the arcuate groove 216. In this example, the trolley 224 includes four rollers 226, 228, 230, 232, two rollers per arcuate groove 216, 218. Each roller 226, 228, 230, 232 is retained in the corresponding groove 216, 218 by a tab 234, 236, 238, 240 which captures the arcuate guide 212, 214 between the roller and the tab. FIG. 10 is an isometric cross sectional view of a portion of the third joint 220, taken along a sagittal plane centered on arcuate guide 212 of the third joint 220. The rollers 226, 228 are visible, as are lower extensions of the tabs 234, 236. The third joint axis 222 extends along the common centers of the bilateral arcuate grooves 216, 218; in other words, along the centerline of their common cylindrical surface.

The example shown provides a total of 60 degrees of rotational adjustment, which may be represented as +20 degrees in flexion and −40 degrees in extension from a zero position. The zero position may also be referred to as an anatomically neutral position or a nominal position with respect to rotation about the medial-lateral axis. In other examples, rotational adjustment less than or greater than 60 degrees may be provided, or the flexion/extension distribution may be different. Indicia 237, 239 may be provided on the gimbal 184 and the trolley 224 to indicate the relative rotational position of the trolley 224 with respect to the gimbal 184. In the example, an edge of the tab 234 serves as indicia 239.

The third joint 220 may be moved or adjusted manually. Since this joint may be actuated multiple times during a surgical operation such as total ankle arthroplasty, there is no positive drive mechanism. This joint is provided with friction-reducing features, notably the rollers, in order to minimize apparatus resistance. By minimizing apparatus resistance, the flexion/extension motion of the ankle joint feels natural to the one manipulating the positioning apparatus 100. This natural tactile feedback is beneficial in assessing joint function, as is done during trialing steps and final implantation steps in arthroplasty procedures. A lever 242 on one side of the third joint 220 may be used to lock out the third joint 220. An independent second lever may be provided on the other side of the third joint 220. FIG. 11A is an isometric detail view of the locking mechanism of the third joint 220; and FIG. 11B is an isometric cross sectional view of a portion of the third joint 220, taken along a transverse plane through the centerline of a shaft 244 of the locking mechanism of the third joint 220.

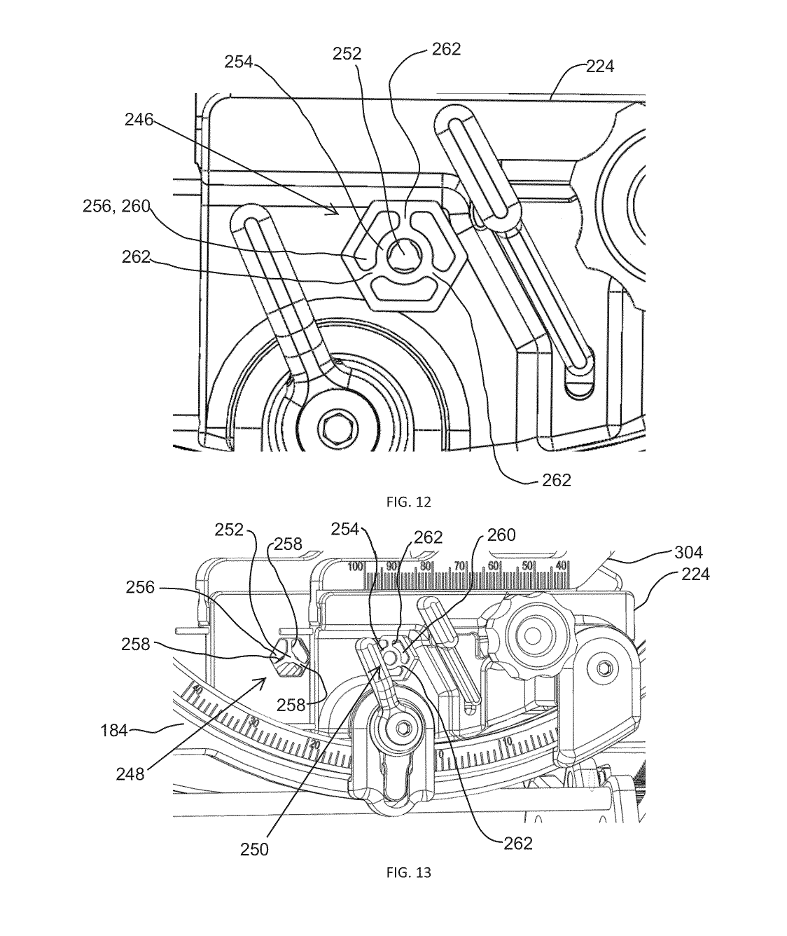

The trolley 224 also includes a lateral alignment aid 246 to indicate when proper lateral alignment of external equipment is achieved. For example, an external fluoroscopy unit or C-arm may be used during some surgical techniques. Portions of the lateral alignment aid 246 are located on contralateral sides of the trolley 224. On one side of the trolley 224, a first portion 248 of the lateral alignment aid 246 includes a central bullseye circle 252 suspended within an aperture 256 by ribs 258. On the other side of the trolley 224, a second portion 250 of the lateral alignment aid 246 includes a central ring 254, which may have an inside diameter equal to or greater than the outer diameter of the bullseye circle 252. The ring 254 is suspended within an aperture 260 by ribs 262. FIG. 12 is a lateral detail view of a portion of the base subassembly 102, showing the bilateral portions 248, 250 of the alignment aid 246 perfectly aligned so that the bullseye circle 252 is centered in the ring 254 and the ribs 258, 262 overlap. FIG. 13 is an oblique lateral detail view of a portion of the base subassembly 102, showing the bilateral portions 248, 250 of the alignment aid 246 misaligned.

The trolley 224 also includes a linear support 264. The example shows a trolley 224 with bilateral linear supports 264, 266. Each linear support 264, 266 includes a linear dovetail groove 268, 270, respectively. The linear dovetail grooves 268, 270 may be defined by a common planar surface which extends across the width of the trolley 224, so that both grooves 268, 270 are coplanar but spaced apart across the width of the trolley 224.

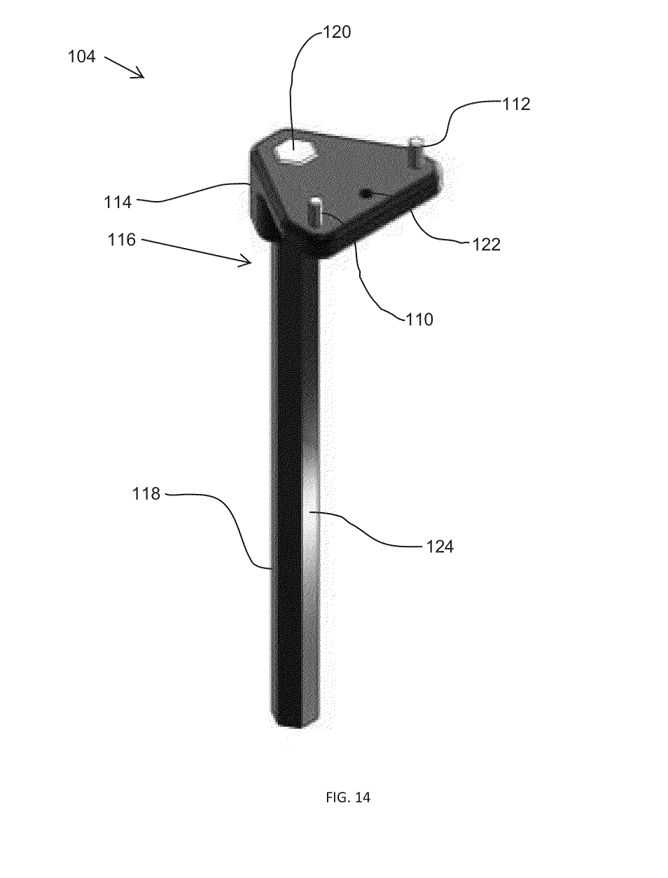

FIG. 14 is an isometric view of a mounting post subassembly 104 for use with the positioning apparatus 100. The mounting post subassembly 104 includes a first pin 110 and a second pin 112. The pins 110, 112 are carried by a mounting plate 114 which is coupled to a first end 116 of a shaft 118. The mounting plate 114 may be triangular, and may be coupled to the first end 116 by a bolt 120. The mounting plate 114 may include a hole 122 located between the pins 110, 112. The hole 122 may be internally threaded. The shaft 118 may include at least one anti-rotation feature 124, such as a flat portion, a keyway, or the like. Shaft 118 may be hexagonal as shown.

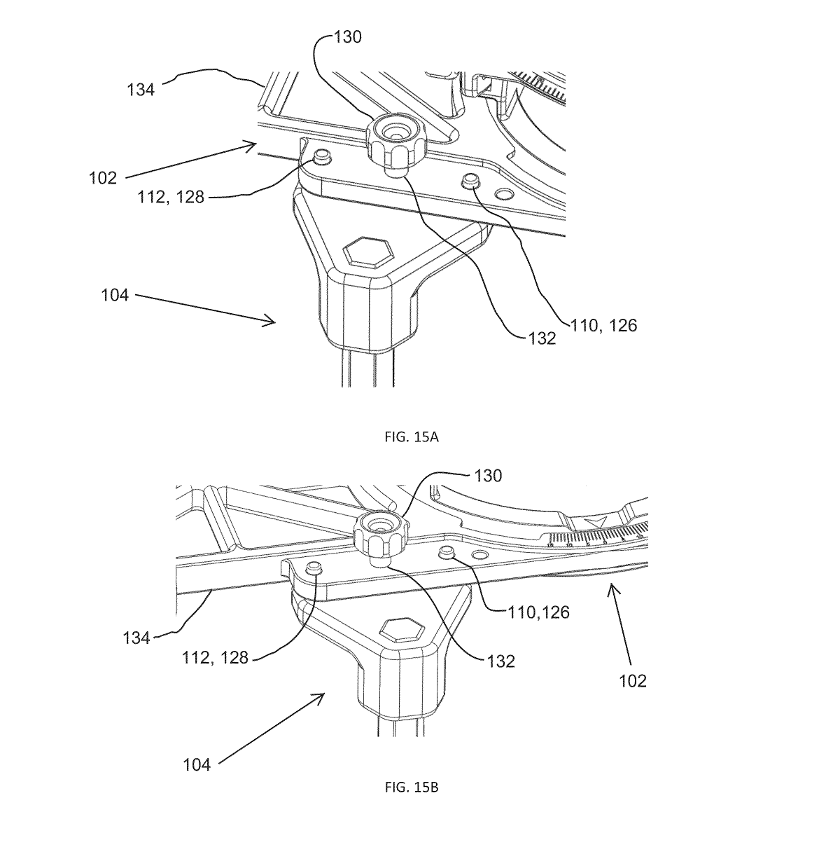

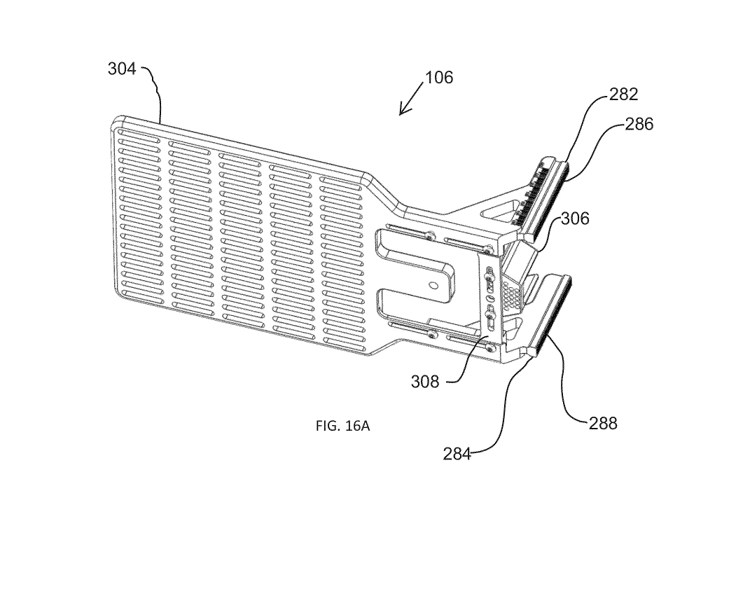

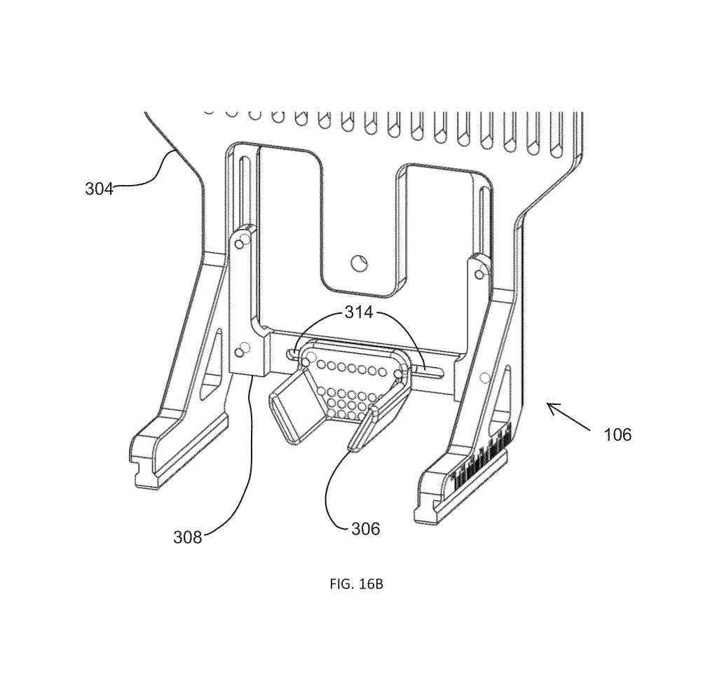

FIG. 15A is an isometric detail view of the base subassembly 102 coupled to the mounting post subassembly 104; and FIG. 15B is another isometric detail view of the base subassembly 102 coupled to the mounting post subassembly 104, from another viewpoint. Pin 110 is received in hole 126, pin 112 is received in hole 128, and thumbscrew 130 extends throu gh hole 132 and threads into hole 122. The thumbscrew 130 couples the base subassembly 102 to the mounting post subassembly 104 without the need for a tool. The pins 110, 112 in holes 126, 128 provide rotational stability and bear most of the mounting loads. In the example shown, the thumbscrew 130 is a loose part when it is not threaded into hole 122. In other examples, the thumbscrew 130 may be captive to the base subassembly 102 or the mounting post subassembly 104. The thumbscrew 130 may thread into hole 132.

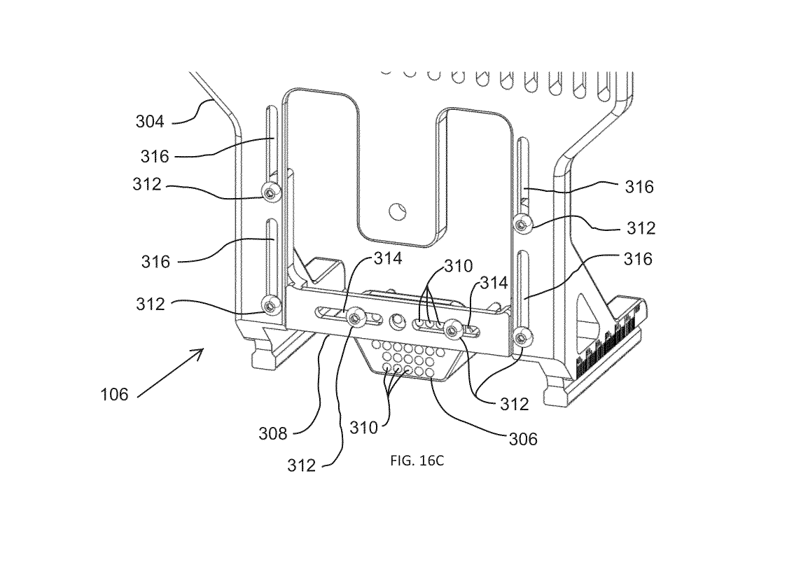

FIG. 16A is an isometric view of a foot plate subassembly 106 of the positioning apparatus 100; FIG. 16B is an isometric detail view of a portion of the foot plate subassembly 106; and FIG. 16C is another isometric detail view of a portion of the foot plate subassembly 106, from another viewpoint. The foot plate subassembly 106 may also be referred to simplay as a plate subassembly 106. The foot plate subassembly 106 includes a foot plate 304 and two heel plates 306, 308 that allow for medial-lateral and anterior-posterior positioning of the heel. A first heel plate 306 is movable in a medial-lateral direction relative to the foot plate 304, and securable in a desired position by fasteners 312 in slots 314. Heel plate 306 also includes multiple holes 310 which may engage guide wires or bone pins (not shown) which extend into the calcaneus 8 or other bones of the ankle and/or foot. A second heel plate 308 is movable in an anterior-posterior direction relative to the foot plate 304, and securable in a desired position by fasteners 312 in slots 316. The second heel plate 308 may be coupled directly to the foot plate 304 and may carry the first heel plate 306, as shown in the example.

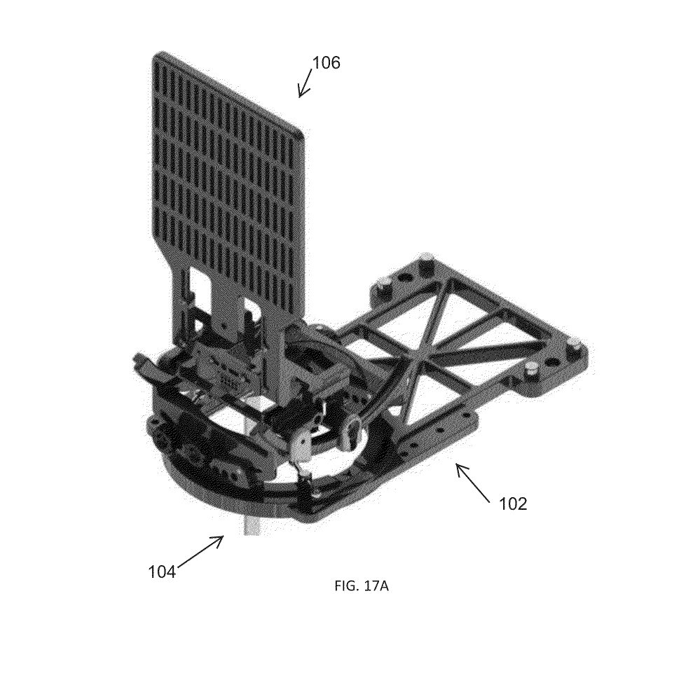

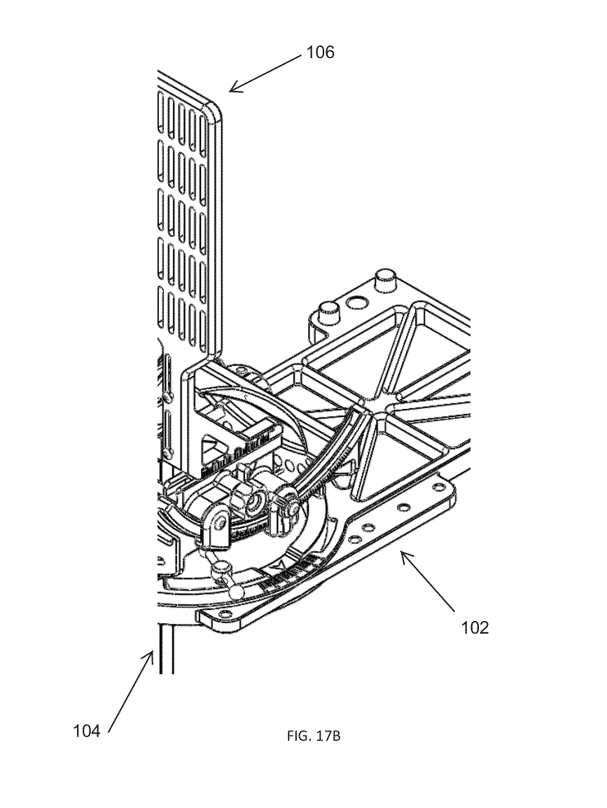

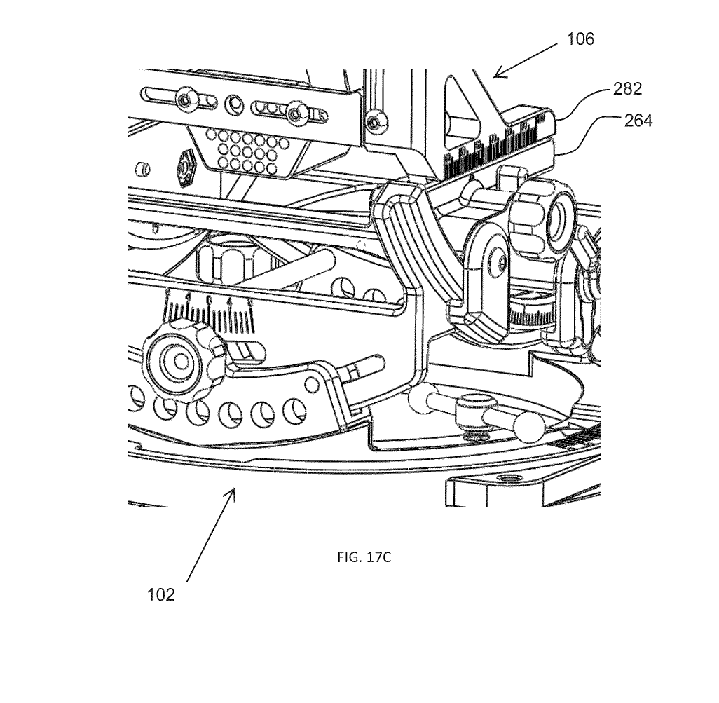

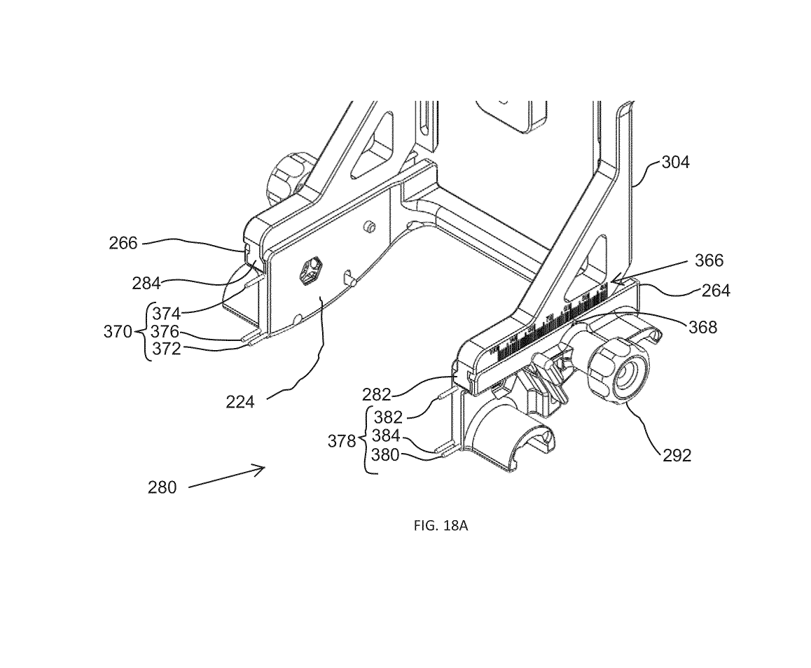

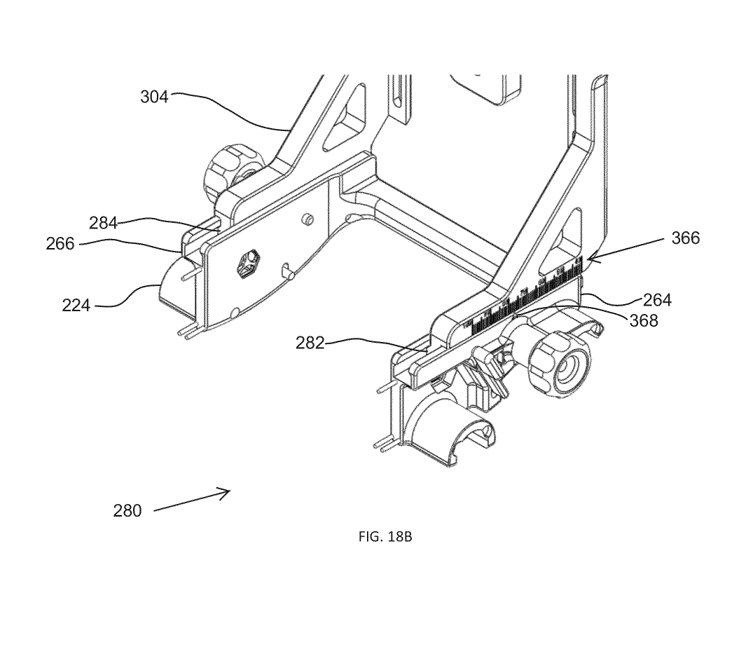

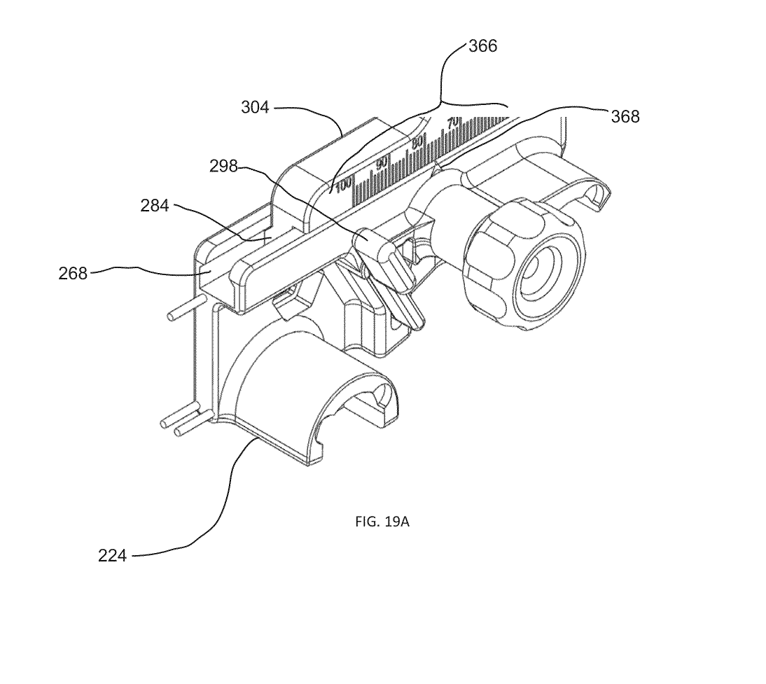

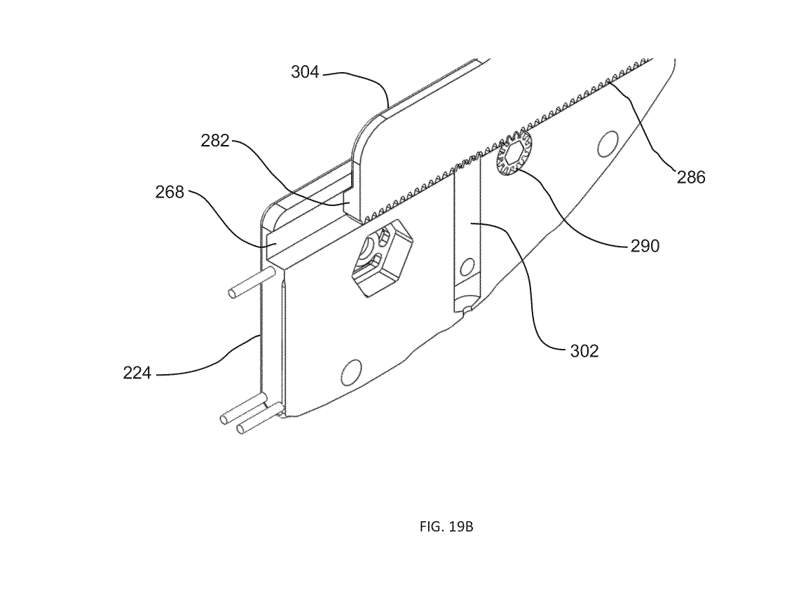

FIG. 17A is an isometric view of the base subassembly 102 coupled to the foot plate subassembly 106; FIG. 17B is an isometric detail view of the base subassembly 102 and foot plate subassembly 106; and FIG. 17C is another isometric detail view of the base subassembly 102 and foot plate subassembly 106, from another viewpoint. FIG. 18A is an isometric view of a fourth joint 280 between the base subassembly 102 and the foot plate subassembly 106, the foot plate subassembly 106 in a first position relative to the base subassembly 102; and FIG. 18B an isometric view of the fourth joint 280, the foot plate subassembly 106 in a second position relative to the base subassembly 102. FIG. 19A is an isometric detail view of the fourth joint 280; and FIG. 19B is an isometric cross sectional view of the fourth joint 280, taken along a plane centered on the support 264 of the fourth joint 280.

The fourth joint 280 provides a fourth degree of freedom of the positioning apparatus 100, which is translation parallel to a superior-inferior axis 182. The axis 182 may also be described as the intersection of a sagittal plane and a coronal plane. The fourth joint 280 permits axial translation of the lower leg, ankle, and foot parallel to a longitudinal axis 182 of the tibia.

The fourth joint 280 includes the linear support 264 of the trolley 224 and the foot plate 304 of the foot plate subassembly 106. The foot plate 304 includes a corresponding linear dovetail feature 282 to engage the support 264. Bilateral dovetail features 282, 284 are shown, corresponding to the bilateral linear supports 264, 266 on the trolley 224. The linear dovetail features 282, 284 may be defined by a common planar surface which extends across the width of the foot plate 304, so that both features 282, 284 are coplanar but spaced apart across the width of the foot plate 304.

The example shown provides a total of 100 mm of linear adjustment from a zero position. The zero position may also be referred to as an anatomically neutral position or a nominal position with respect to anterior-posterior translation. In other examples, linear adjustment less than or greater than 100 mm may be provided. Indicia 366, 368 may be provided on the dovetail features 282, 284 and supports 264, 266 to indicate the relative linear position of the foot plate 304 with respect to the trolley 224.

The foot plate subassembly 106 has linear motion with respect to the trolley 224. Motion of the foot plate subassembly 106 is driven by a pair of rack-and-pinion gears, one on each side of the fourth joint 280. The rack teeth 286, 288 are visible in FIG. 16A. The pinion gear 290 is coupled to a knob 292 which is visible in FIG. 18A. Another pinion gear 294 and knob 296 are included on the other side of the fourth joint 280. FIG. 19B shows the rack 286 and pinion 290 engaged. The position of the foot plate subassembly 106 relative to the trolley 224 is maintained by a pair of latches 298, 300 which are indexed to the rack gears 286, 288. The latches 298, 300 may be locked out to allow for free motion of the foot plate subassembly 106 when desired. FIG. 19B shows a locking element 302 which is actuated by the latch 298. The locking element 302 is shown meshed with the rack teeth 286.

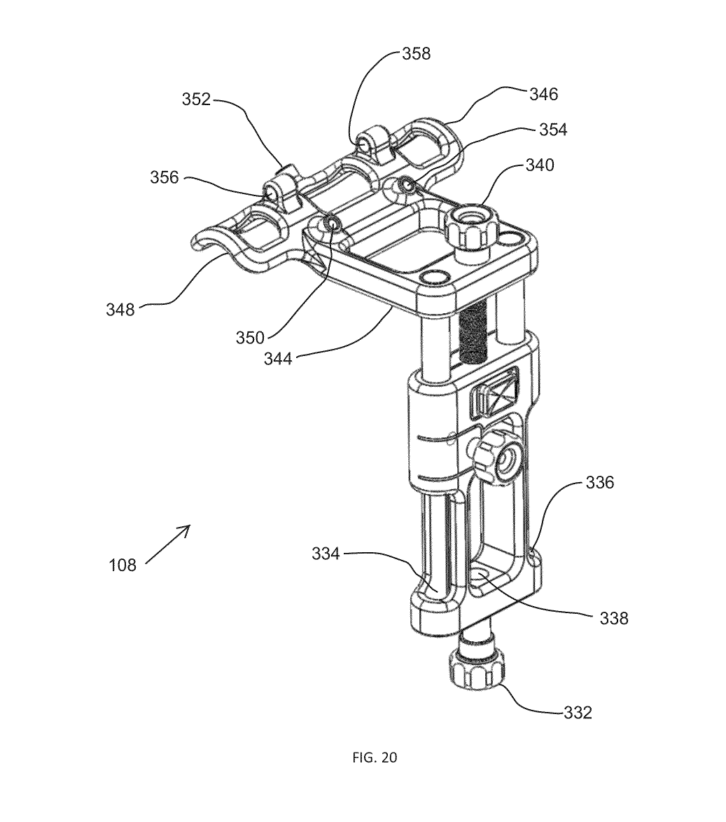

FIG. 20 is an isometric view of a tibial clamp subassembly 108 of the positioning apparatus 100. The tibial clamp subassembly 108 may also be referred to as a limb clamp subassembly.

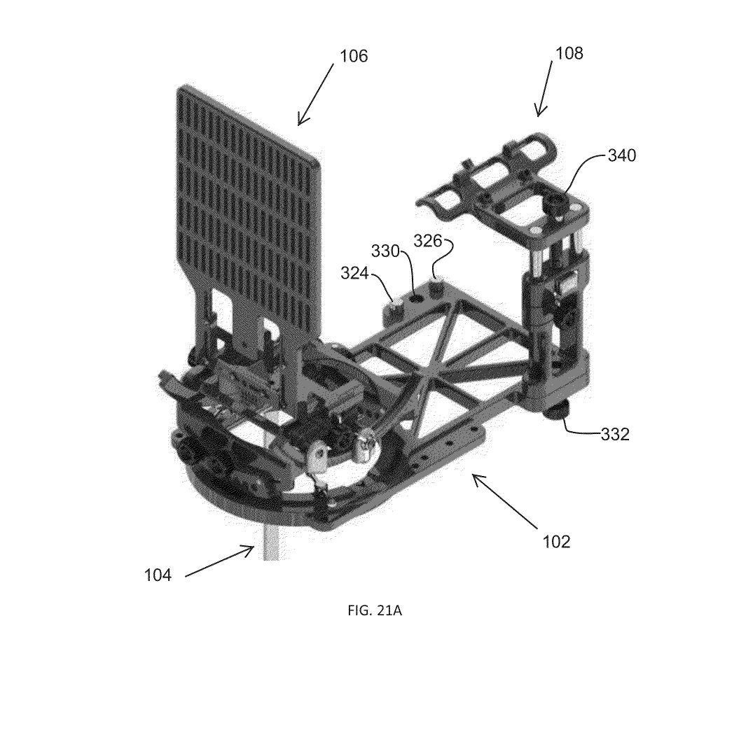

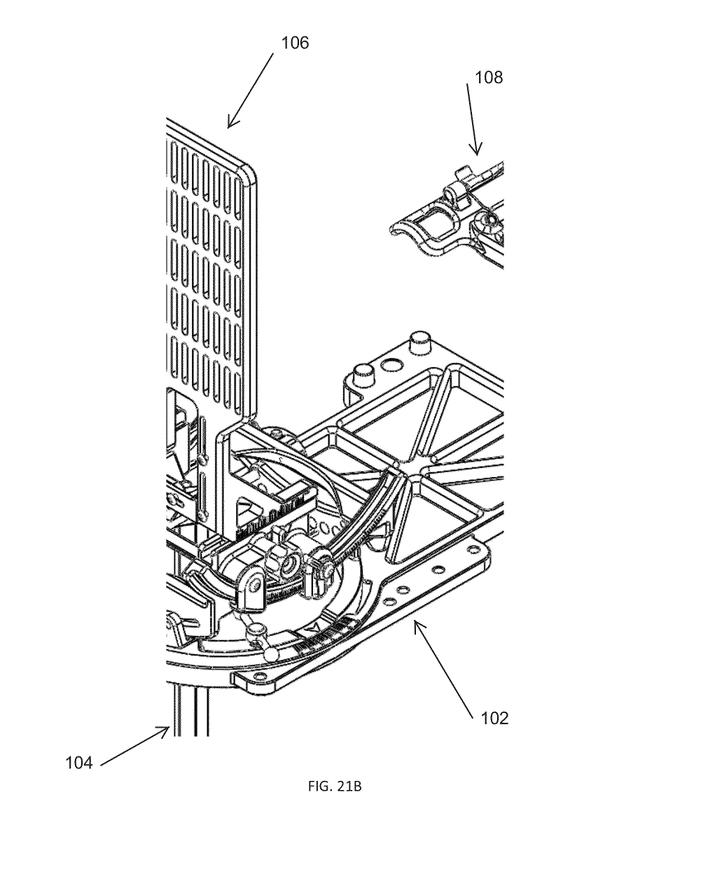

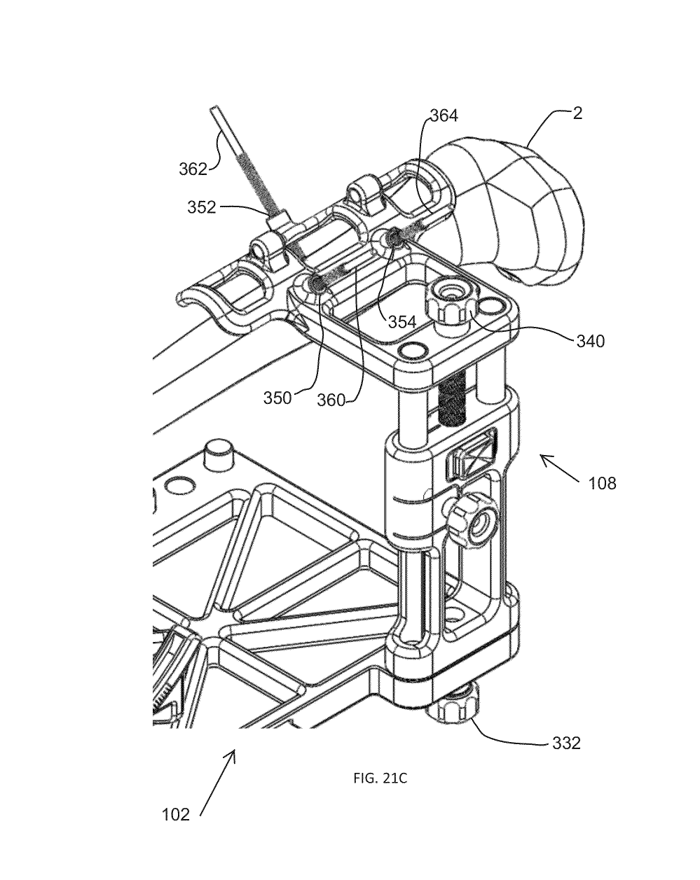

FIG. 21A is an isometric view of the base subassembly 102 and foot plate subassembly 106 coupled to the tibial clamp subassembly 108; FIG. 21B is an isometric detail view of a portion of the base subassembly 102, foot plate subassembly 106, and tibial clamp subassembly 108; FIG. 21C is an isometric detail view of a portion of the base subassembly 102, foot plate subassembly 106, and tibial clamp subassembly 108; and FIG. 21D is an isometric cross sectional detail view of a portion of the base subassembly 102, foot plate subassembly 106, and tibial clamp subassembly 108, taken along a sagittal plane through the centerline of a shaft of the tibial clamp subassembly 108.

The tibial clamp subassembly 108 holds the lower leg against the base subassembly 102. It is attached to the base subassembly 102 via two protrusions 320, 322, which are received in holes 334, 336; and a single thumbscrew 332, which extends through the hole 328 and threads into the hole 338. The height of the plate is adjustable via a thumbscrew 340. The thumbscrew 340 includes a speed nut 342 to allow for rapid adjustments. The tibial clamp subassembly 108 is symmetric so that it can attach to either side of the positioning apparatus 100 for left or right use. The tibial plate 344 includes superior and inferior extensions 346, 348. These allow the tibia to be provisionally attached to the clamp using tape, gauze, elastic wrap, or the like. The tibial plate 344 also includes holes 350, 352, 354. Holes 350, 352, 354 may engage guide wires or bone pins 360, 362, 364 which extend into the tibia 2, fibula 4, or other bones of the ankle and/or foot. The tibial plate 344 also includes holes 356, 358 which are coaxial.

Method of Use

A method of using the positioning apparatus 100 may include the following steps in the stated order. However, the positioning apparatus 100 may be used according to various other methods. For example, selected steps described below may be omitted from some methods of use. Other methods of use may include additional steps. Yet other methods of use may organize the steps in different sequences. One of skill in the art will appreciate the adaptability of the positioning apparatus 100 to numerous methods of use.

The mounting post subassembly 104 may be coupled to a support structure by clamping the shaft 118 to a rail of a surgical table with a rail clamp.

The base subassembly 102 may be coupled to the mounting post subassembly 104 by inserting the pin 110 in hole 126, inserting the pin 112 in hole 128, inserting the thumbscrew 130 through hole 132, and threading the thumbscrew 130 into hole 122. The mounting post subassembly 104 may optionally be coupled to the opposite side of the base subassembly 102.

The foot plate subassembly 106 may be coupled to the base subassembly 102 by locking out the latches 298, 300, sliding the dovetail feature 282 into groove 268, sliding the dovetail feature 284 into groove 270, aligning the indicia 368 with indicia 366, and unlocking the latches 298, 300.

The tibial clamp subassembly 108 may be coupled to the base subassembly 102 by inserting the protrusion 320 in hole 334, inserting the protrusion 322 in hole 336, inserting the thumbscrew 332 through hole 328, and threading the thumbscrew 332 into hole 338. The tibial clamp subassembly 108 may optionally be coupled to the opposite side of the base subassembly 102.

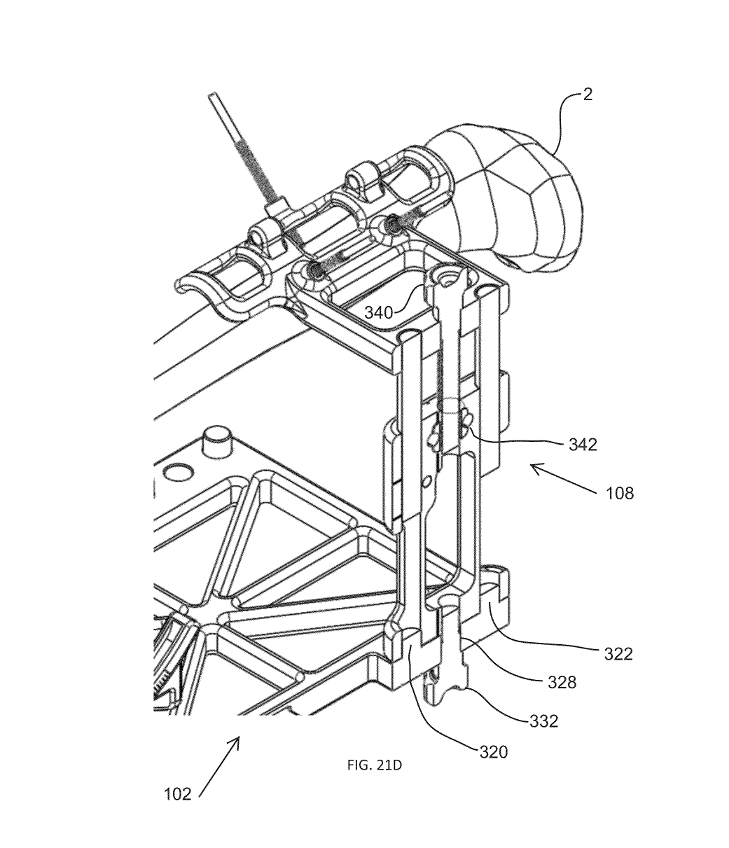

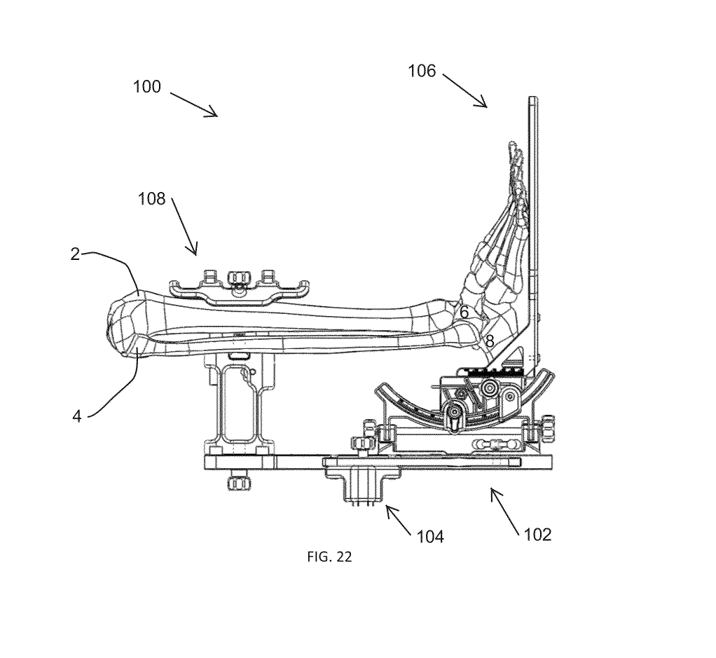

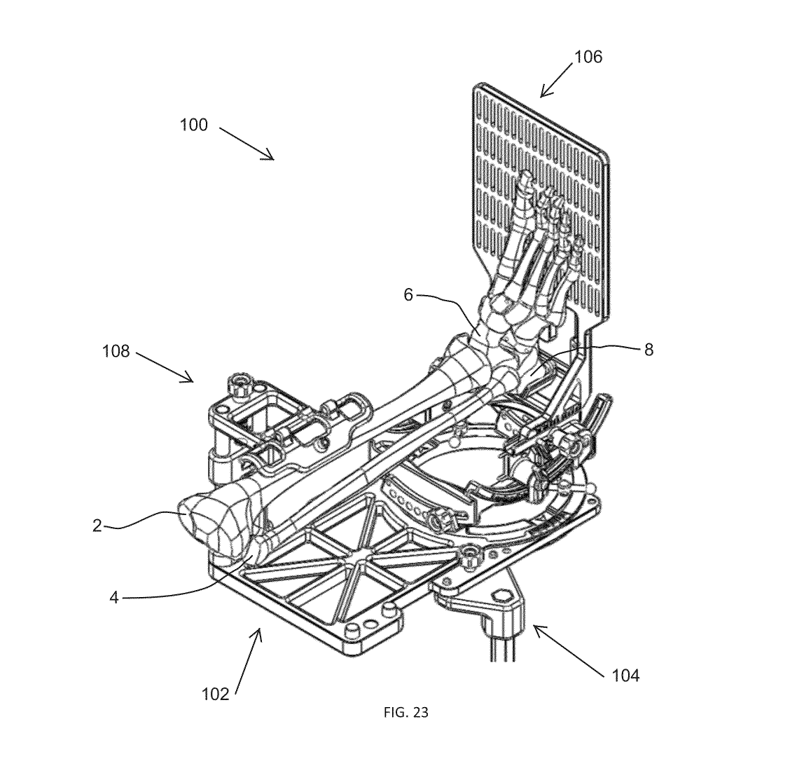

The lower leg, ankle, and foot may be initially positioned relative to the positioning apparatus 100 by placing the heel in the cup of the first heel plate 306 and binding the tibia to the tibia plate 344 with tape, gauze, elastic wrap, or the like. The lower leg, ankle, and foot are still movable with respect to the positioning apparatus 100 after this step. FIG. 22 is a lateral view of the base subassembly 102, foot plate subassembly 106, and tibial clamp subassembly 108 initially coupled to the bones of the lower leg, ankle, and foot. FIG. 23 is an isometric view of the base subassembly 102, foot plate subassembly 106, tibial clamp subassembly 108 initially coupled to the bones of the lower leg, ankle, and foot.

A fluoroscopy unit or other external equipment may be calibrated to the positioning apparatus 100 in a lateral view by aiming the fluoroscopy unit at the lateral alignment aid 246 and assessing the appearance of the lateral alignment aid 246 in an image from the fluoroscopy unit. The steps of aiming and assessing may be repeated until the lateral alignment aid 246 indicates perfect lateral alignment as shown in FIG. 12.

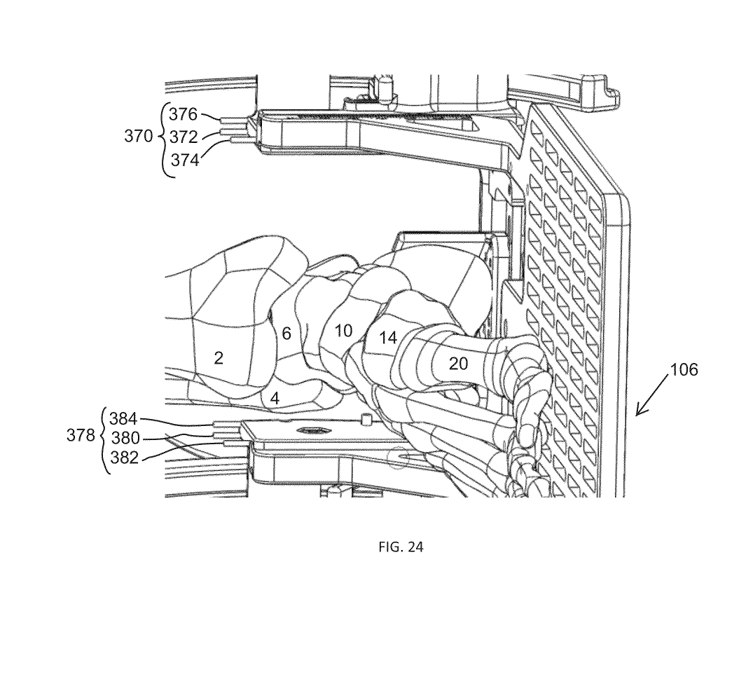

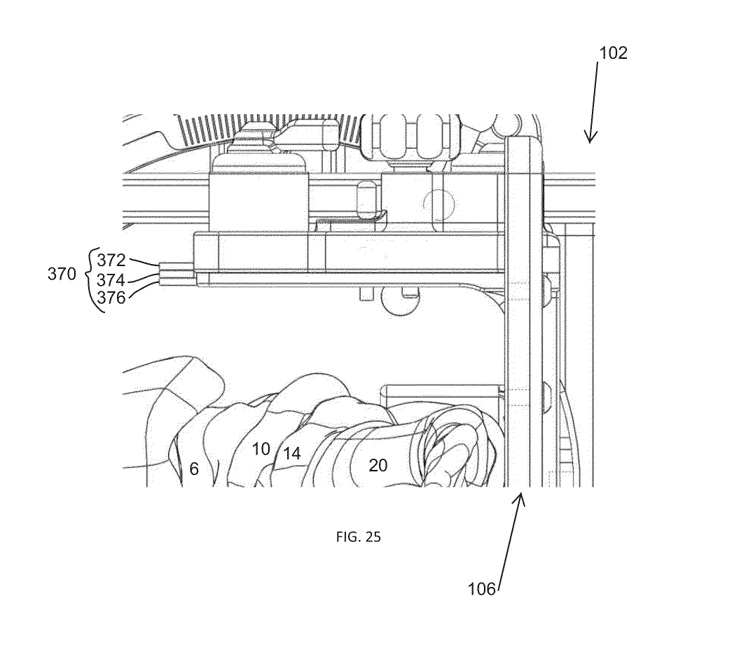

A fluoroscopy unit or other external equipment may be calibrated to the positioning apparatus 100 in an anterior view by aiming the fluoroscopy unit at an anterior alignment aid 370 and assessing the appearance of the anterior alignment aid 370 in an image from the fluoroscopy unit. The steps of aiming and assessing may be repeated until the anterior alignment aid 370 indicates perfect lateral alignment as shown in FIG. 25. The anterior alignment aid 370 shown in the example is a pattern of three pins 372, 374, 376 whose tips align evenly to indicate proper anterior alignment. A second anterior alignment aid 378 may be included, with pins 380,382, 384. FIG. 24 is an anterior oblique detail view of a portion of the base subassembly 102, foot plate subassembly 106, tibial clamp subassembly 108, and bones of the lower leg, ankle, and foot. In this view, the anterior alignment aid 370 is misaligned. FIG. 25 is an anterior detail view of a portion of the base subassembly 102, foot plate subassembly 106, tibial clamp subassembly 108, and bones of the lower leg, ankle, and foot. In this view, the anterior alignment aid 370 is perfectly aligned. The process of aligning an external equipment in both the lateral and anterior uviews may include repeatedly alternating between aligning in the lateral view and aligning in the anterior view.

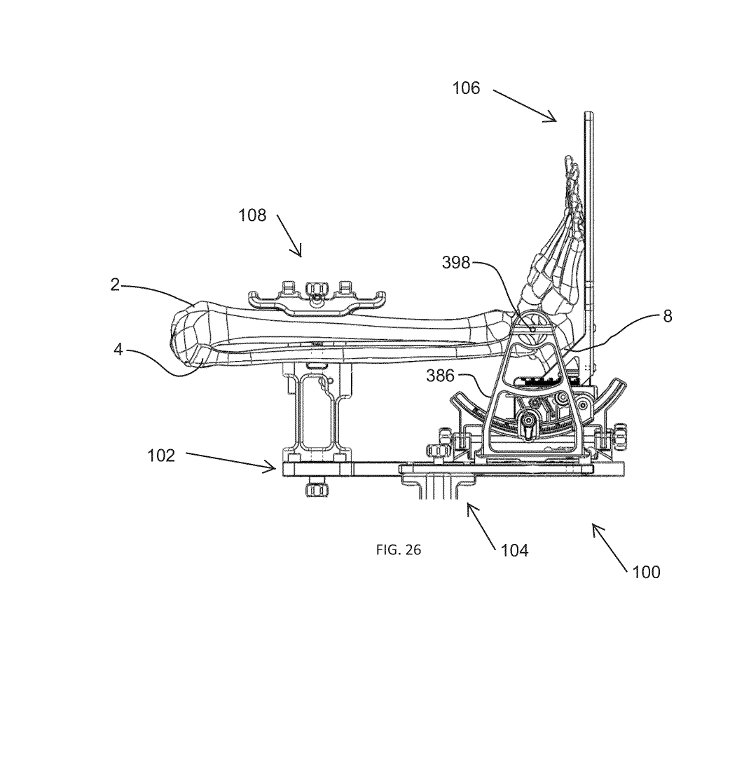

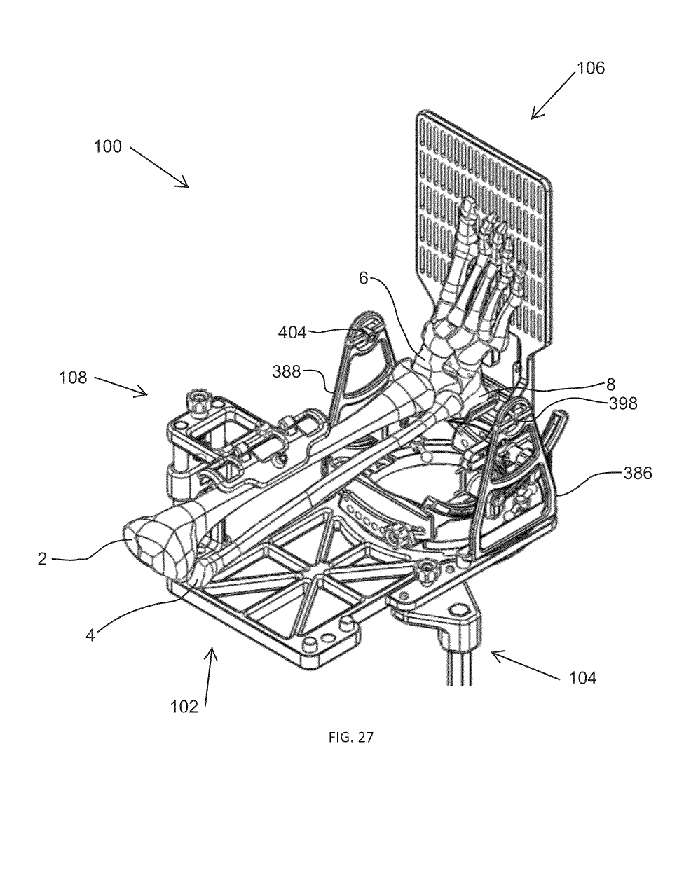

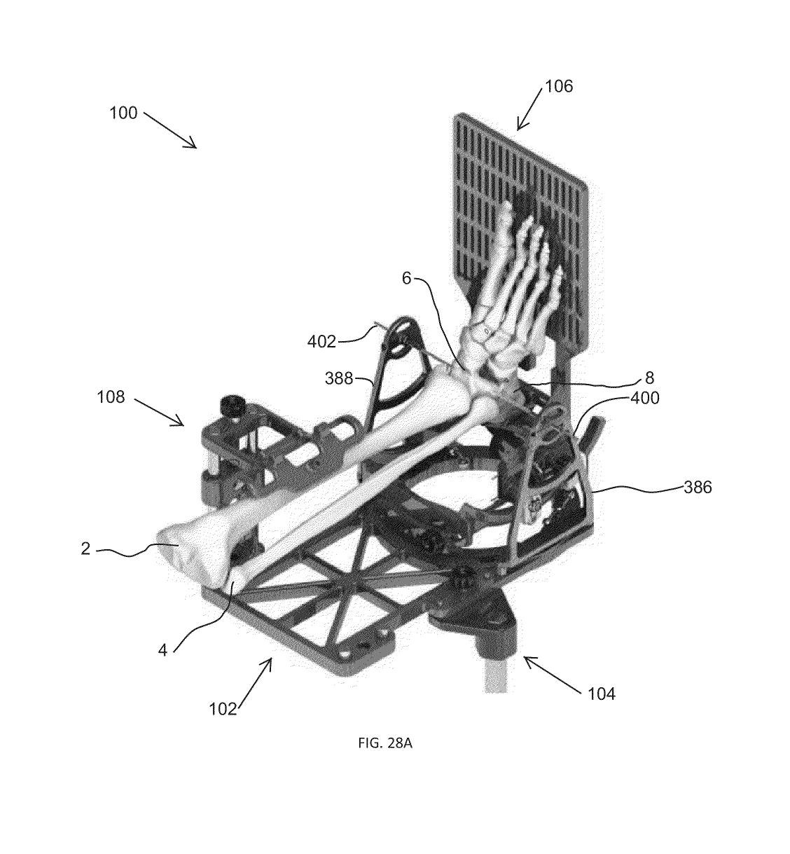

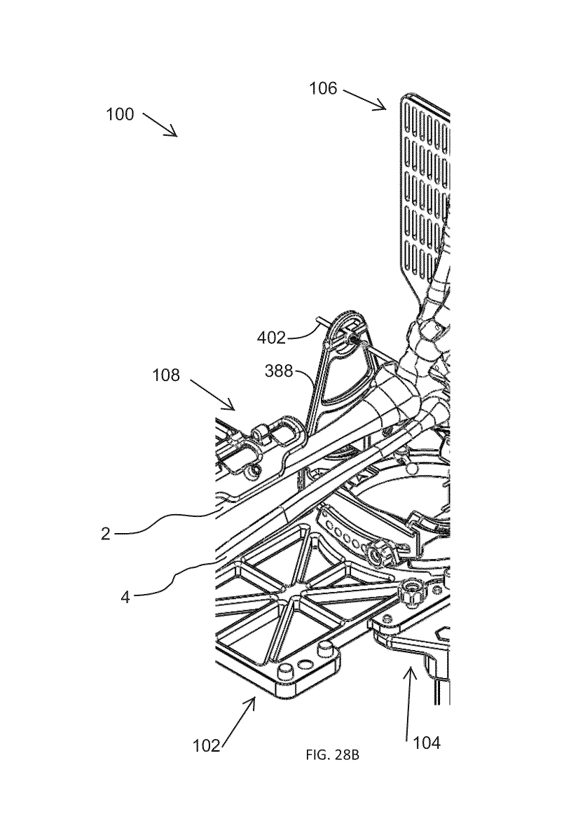

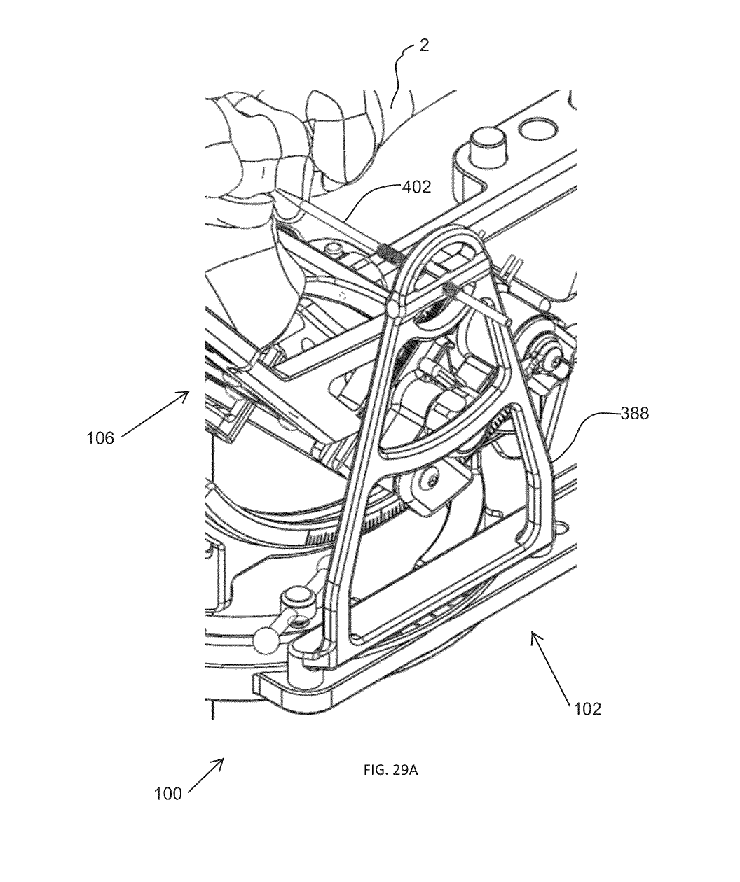

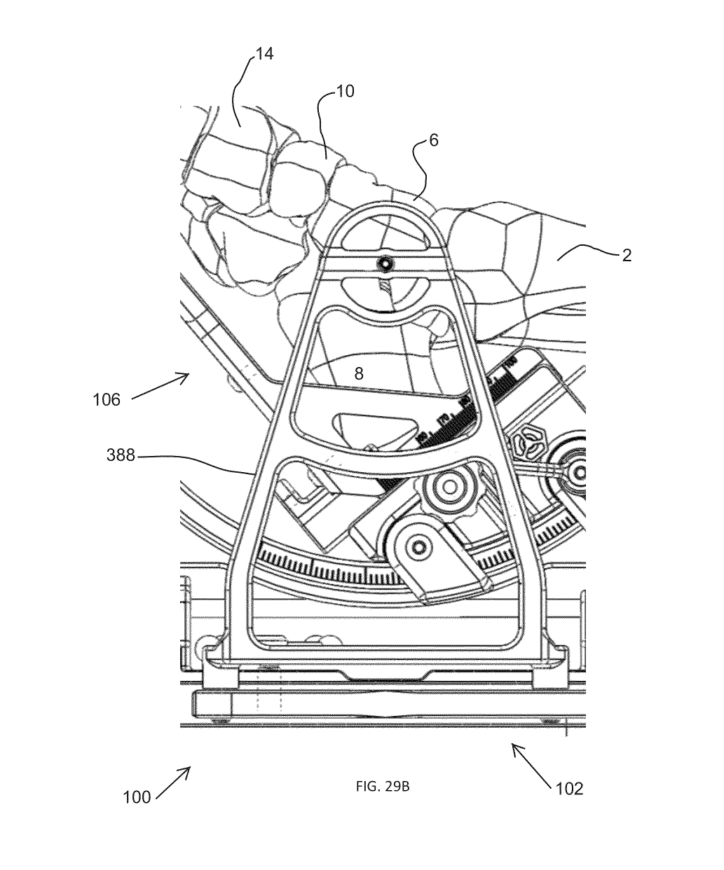

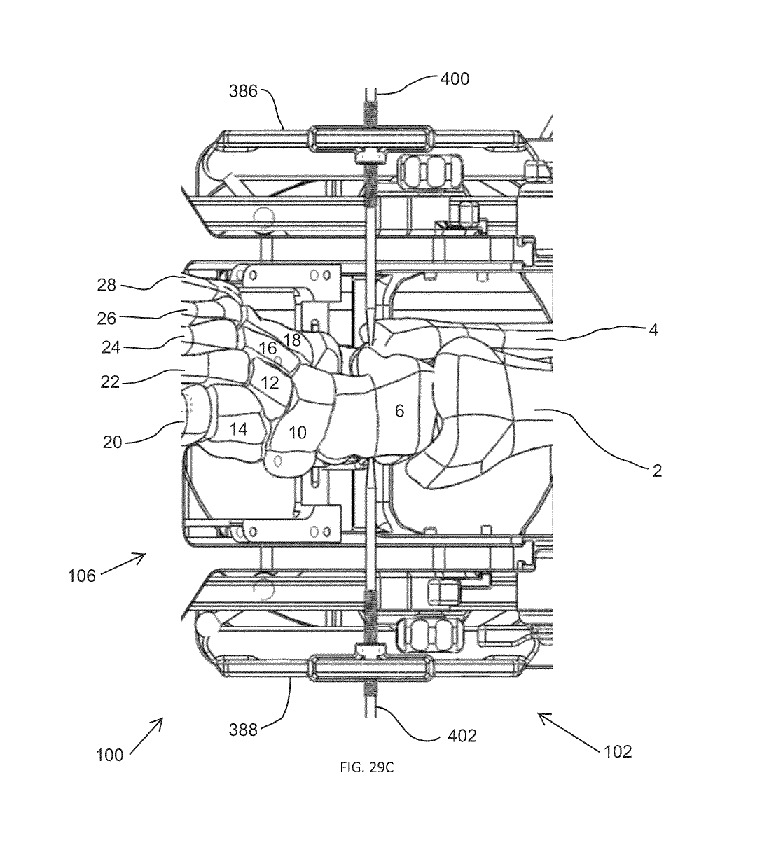

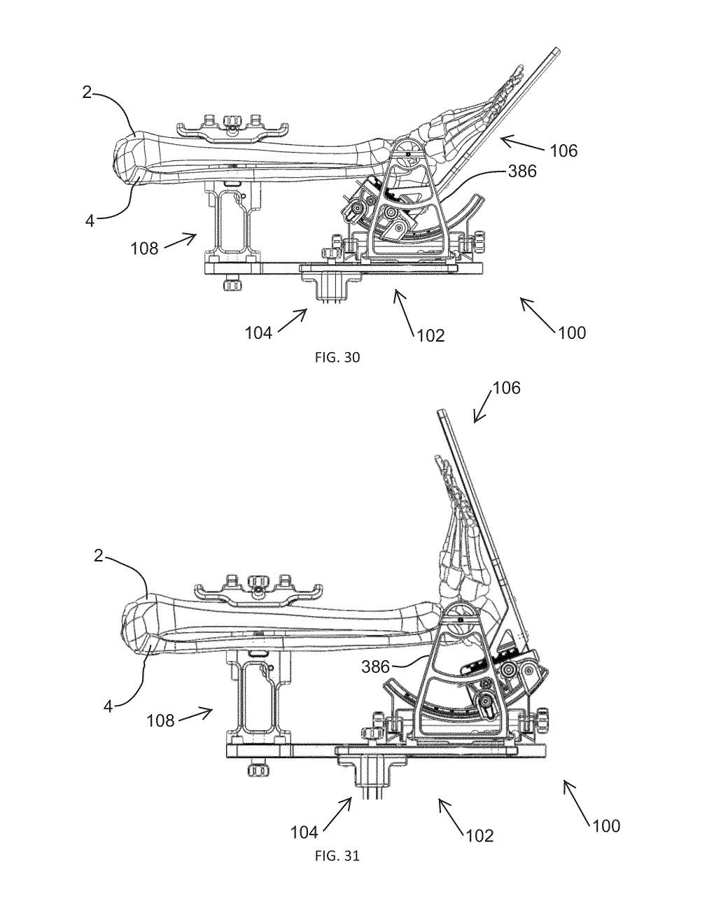

The ankle center of rotation in flexion-extension may be adjusted to coincide with the center of rotation of the positioning apparatus 100 about the third joint axis 222 by coupling a center of rotation target 386 to the positioning apparatus 100, coupling a pin 400 to the center of rotation target 386, advancing the pin 400 to contact the ankle, adjusting the foot plate subassembly to move the ankle relative to the pin 400, and moving the third joint 220 to assess rotation of the ankle versus the pin 400. The steps of adjusting and moving may be repeated until the ankle center of rotation coincides with the pin 400. The center of rotation target 386 may be coupled to the positioning apparatus 100 by inserting protrusions on the center of rotation target 386 into holes 390, 392 in the base plate 134. The pin 400 may be coupled to the center of rotation target 386 and advanced to contact the ankle by threading the pin 400 into a hole 398 in the center of rotation target 386. A second center of rotation target 388 may also be included, and may be coupled to the positioning apparatus 100 by inserting protrusions on the center of rotation target 388 into holes 394, 396 in the base plate 134. A pin 402 may be coupled to the center of rotation target 388 and advanced to contact the ankle by threading the pin 402 into a hole 404 in the center of rotation target 388. The foot plate subassembly 106 may be adjusted to move the ankle relative to the pin 400 by actuating the fourth joint 280, moving the first heel plate 306 in a medial-lateral direction relative to the foot plate 304, and/or moving the second heel plate 308 in an anterior-posterior direction relative to the foot plate 304. The third joint 220 may be moved manually to assess rotation of the ankle versus the pin 400 in flexion-extension, as shown in FIGS. 30-31. Once the ankle center of rotation coincides with the pin 400, the first heel plate 306 and/or the second heel plate 308 may be secured relative to the foot plate 304 with fasteners 312. FIG. 26 is a lateral view of the base subassembly 102, foot plate subassembly 106, tibial clamp subassembly 108, and bones of the lower leg, ankle, and foot, with center of rotation targets 386, 388 attached to the base subassembly 102. The center of rotation targets 386, 388 are used to identify the center of rotation of the ankle and position the ankle center of rotation coincident with a center of rotation of the positioning apparatus 100. The center of rotation targets 386, 388 may also be used to position a center of rotation of an implant system being implanted in conjunction with the positioning apparatus 100. The center of rotation targets 386, 388 engage the base plate 134 via a pair of alignment pins on each center of rotation target. FIG. 27 is an isometric view of the base subassembly 102, center of rotation targets 386, 388, foot plate subassembly 106, tibial clamp subassembly 108, and bones of the lower leg, ankle, and foot. FIG. 28A is an isometric detail view of the base subassembly 102, center of rotation targets 386, 388, foot plate subassembly 106, tibial clamp subassembly 108, and bones of the lower leg, ankle, and foot, with pins 400, 402 coupled to the center of rotation targets 386,388 and extending toward the ankle center of rotation. FIG. 29A is an isometric detail view of the base subassembly 102, center of rotation targets 386, 388, pins 400, 402, foot plate subassembly 106, tibial clamp subassembly 108, and bones of the lower leg, ankle, and foot; FIG. 29B is a medial view of the base subassembly 102, center of rotation targets 386, 388, pins 400, 402, foot plate subassembly 106, tibial clamp subassembly 108, and bones of the lower leg, ankle, and foot; and FIG. 29C is an anterior view of the base subassembly 102, center of rotation targets 386, 388, pins 400, 402, foot plate subassembly 106, tibial clamp subassembly 108, and bones of the lower leg, ankle, and foot. FIG. 30 is a lateral view of the base subassembly 102, center of rotation targets 386, 388, pins 400, 402, foot plate subassembly 106, tibial clamp subassembly 108, and bones of the lower leg, ankle, and foot, with the foot and foot plate subassembly 106 in extension. FIG. 31 is a lateral view of the base subassembly 102, center of rotation targets 386, 388, pins 400, 402, foot plate subassembly 106, tibial clamp subassembly 108, and bones of the lower leg, ankle, and foot, with the foot and foot plate subassembly 106 in flexion.

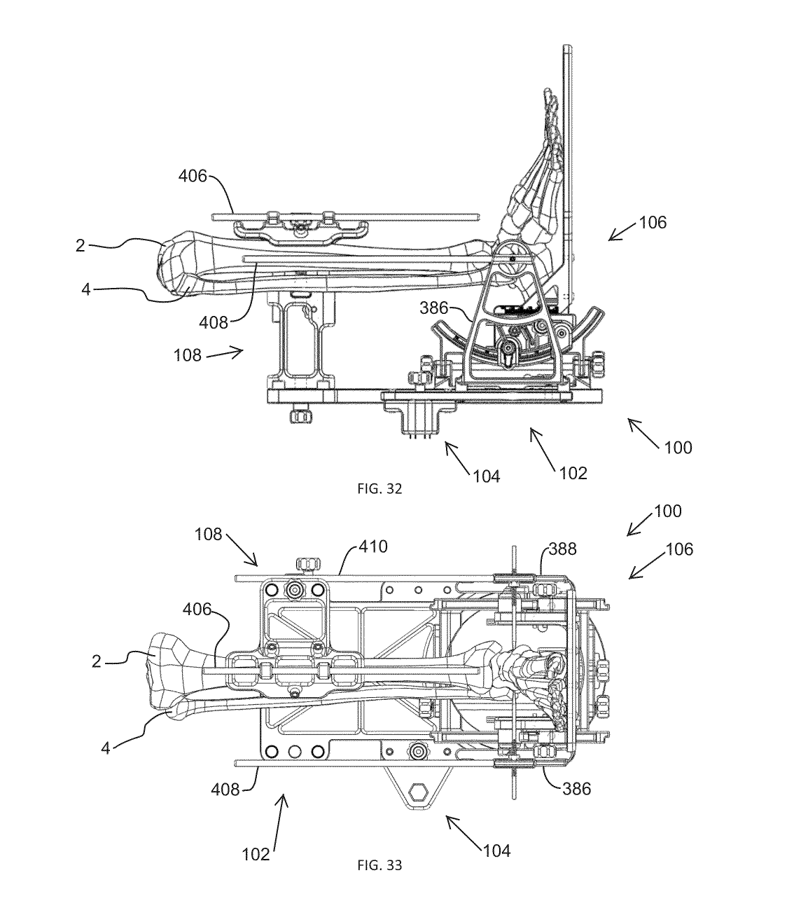

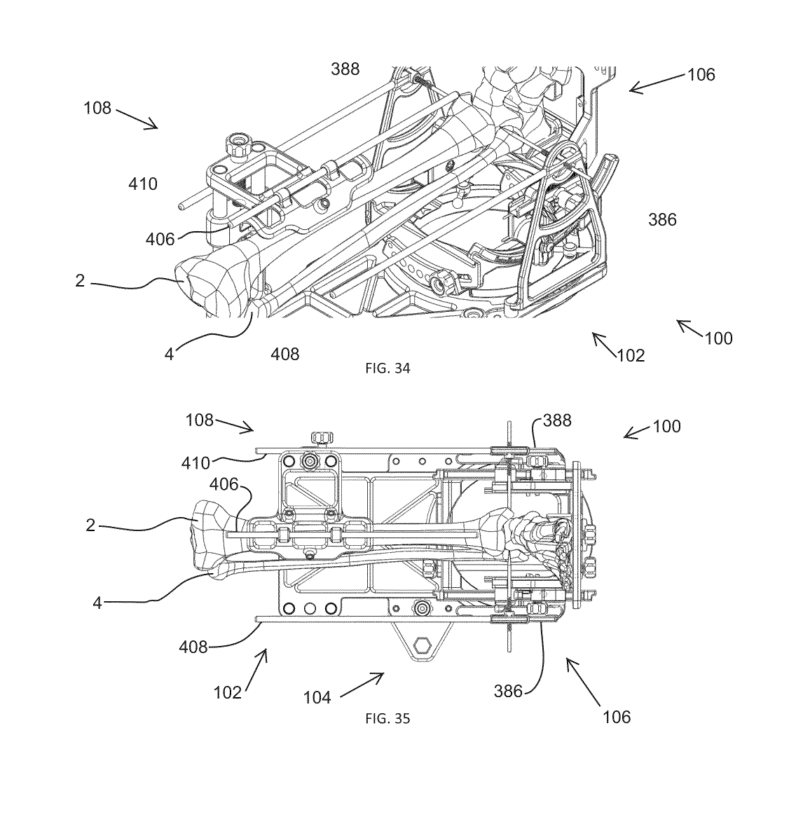

The tibial axis may be aligned to coincide with the second joint axis 182 of the positioning apparatus 100 by inserting a tibial alignment rod 406 in holes 356, 358 of the tibial plate 344, adjusting the height of the tibial plate 344 and/or the medial-lateral position of the first heel plate 306, and assessing proper positioning with fluoroscopy. The steps of adjusting and assessing may be repeated until the tibial axis is perfectly aligned with the second joint axis 182. Once the tibial axis is perfectly aligned with the second joint axis 182, the first heel plate 306 may be secured relative to the foot plate 304 with fasteners 312. Additional tibial alignment rods 408, 410 may be inserted into holes in the center of rotation targets 386, 388. FIG. 32 is a lateral view of the base subassembly 102, center of rotation targets 386, 388, pins 400, 402, foot plate subassembly 106, tibial clamp subassembly 108, and bones of the lower leg, ankle, and foot, with tibial alignment guides 406, 408, 410 coupled to the tibial clamp subassembly 108 and the center of rotation targets 386, 388. FIG. 33 is an anterior view of the base subassembly 102, center of rotation targets 386, 388, pins 400, 402, foot plate subassembly 106, tibial clamp subassembly 108, tibial alignment guides 406, 408, 410, and bones of the lower leg, ankle, and foot. FIG. 34 is an isometric view of the base subassembly 102, center of rotation targets 386, 388, pins 400, 402, foot plate subassembly 106, tibial clamp subassembly 108, tibial alignment guides 406, 408, 410, and bones of the lower leg, ankle, and foot. FIG. 35 is an anterior view of the base subassembly 102, center of rotation targets 386, 388, pins 400, 402, foot plate subassembly 106, tibial clamp subassembly 108, tibial alignment guides 406, 408, 410, and bones of the lower leg, ankle, and foot, with the foot plate subassembly 106 in a different position relative to the base subassembly 102.

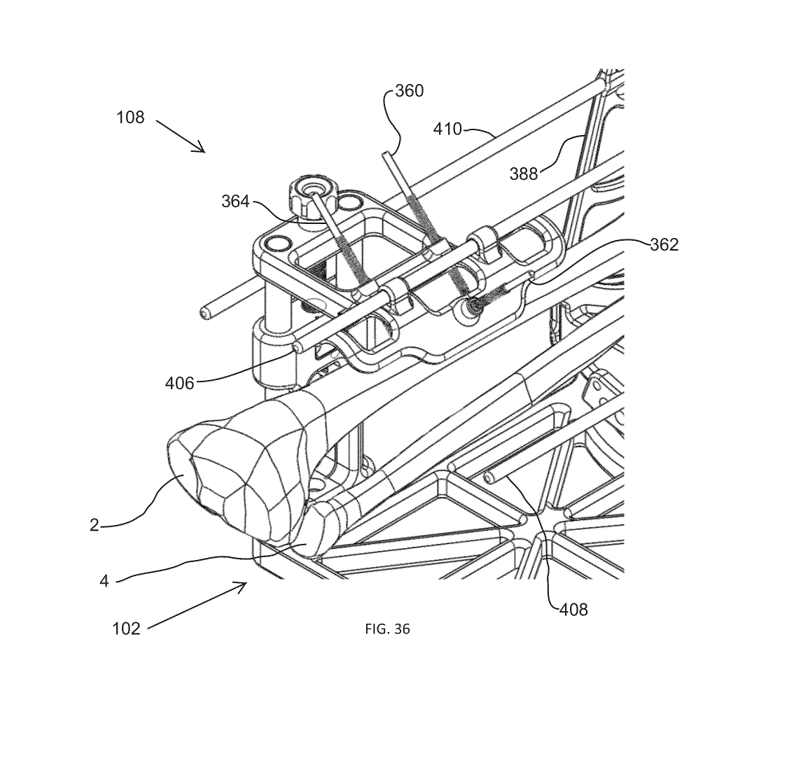

The tibia and calcaneus may be coupled to the positioning apparatus 100 by driving bone pins and/or wires through various bones of the lower leg, ankle, and/or foot. For example, bone pins 360, 362, 364 may be driven into the tibia 2 and/or fibula 4 through holes 350, 352, 354 in the tibial plate 344. Bone pins and/or wires may be driven into the calcaneus 8 through holes 310 in first heel plate 306. Pinning the tibia 2 and calcaneus 8, or other bones of the lower leg, ankle, and/or foot, permits distraction forces to be applied between the pin sites if desired. FIG. 36 is an isometric detail view of the base subassembly 102, center of rotation targets 386, 388, pins 400, 402, foot plate subassembly 106, tibial clamp subassembly 108, tibial alignment guides 406, 408, 410, and bones of the lower leg, ankle, and foot, with bone pins passing through the tibial clamp subassembly 108 and into the bones of the lower leg.

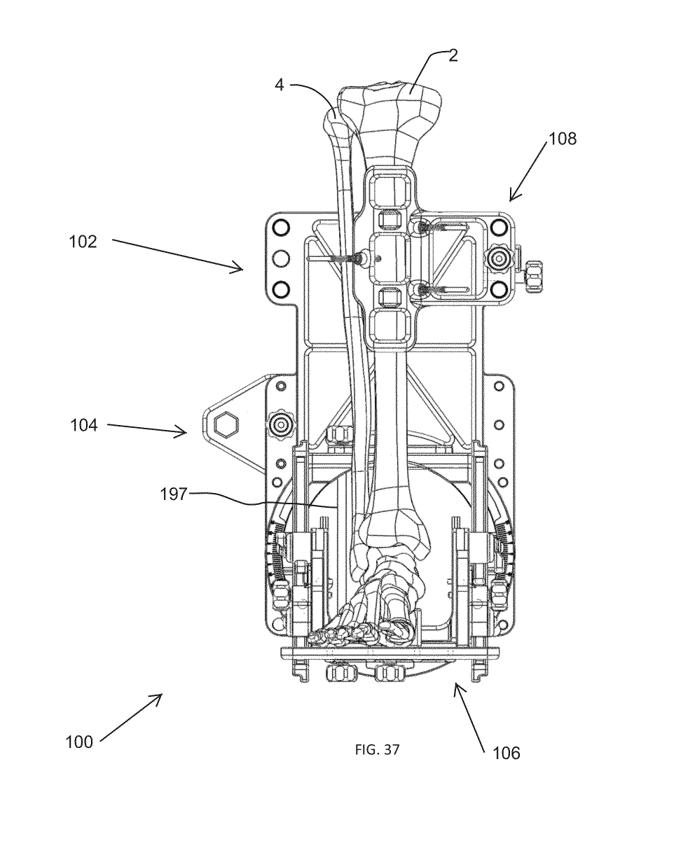

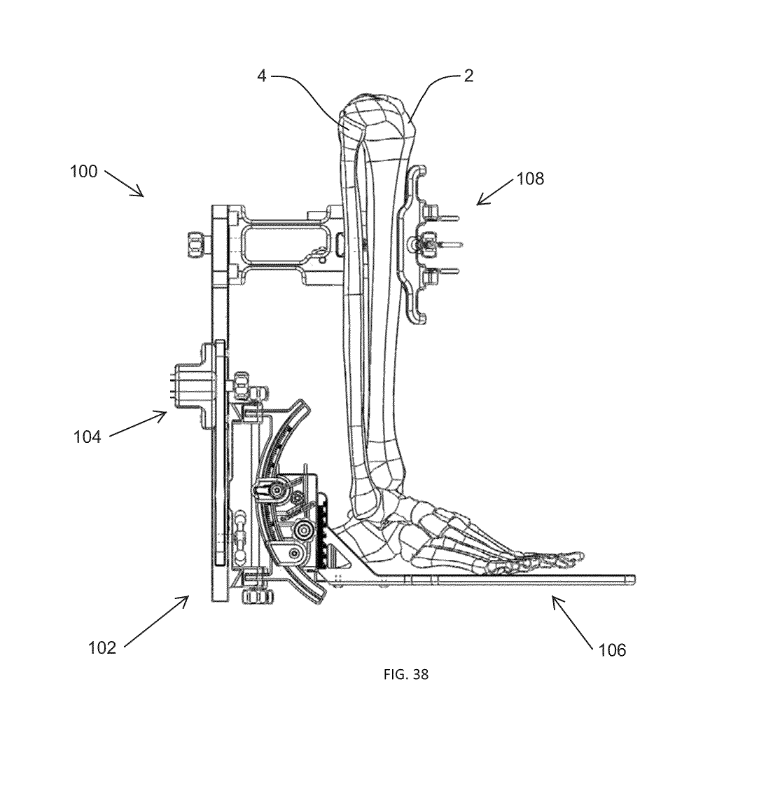

The center of rotation targets 386, 388, pins 400, 402, and tibial alignment rods 406, 408, 410 may be removed by reversing the respective coupling operations. FIG. 1 illustrates a lower leg, ankle, and foot (bones of) which have been completely aligned and pinned to the positioning apparatus 100. At this point, the positioning apparatus 100 has been calibrated to the position of the fluoroscope or other external equipment (or vice versa), and the lower leg, ankle, and foot have been positioned within the positioning apparatus 100 so that the ankle center of rotation coincides to the positioning apparatus 100 center of rotation. The bones are rigidly pinned to the positioning apparatus 100 so that the limb may be manipulated either directly or through actuation of the joints 152, 180, 220, 280 of the positioning apparatus 100. In an anterior view, there is an unobstructed view of the ankle, since no part of the apparatus extends into the vicinity of the ankle joint. FIGS. 29C and 37 illustrate the unobstructed anterior view of the ankle. In a lateral view, there is also an unobstructed view of the ankle, since no part of the apparatus extends anteriorly past the posterior calcaneus.

Subsequent steps may be directed to ankle fusion, ankle arthroplasty, or another therapeutic, surgical, orthopedic, or medical procedure. While this disclosure has emphasized the context of the ankle joint, ankle fusion, and ankle arthroplasty, the positioning apparatus 100 may be useful in other lower leg and/or foot procedures such as trauma, plating, osteotomies, midfoot or forefoot fusions, tendon reattachment or repositioning, and the like.

### Alternative Embodiment

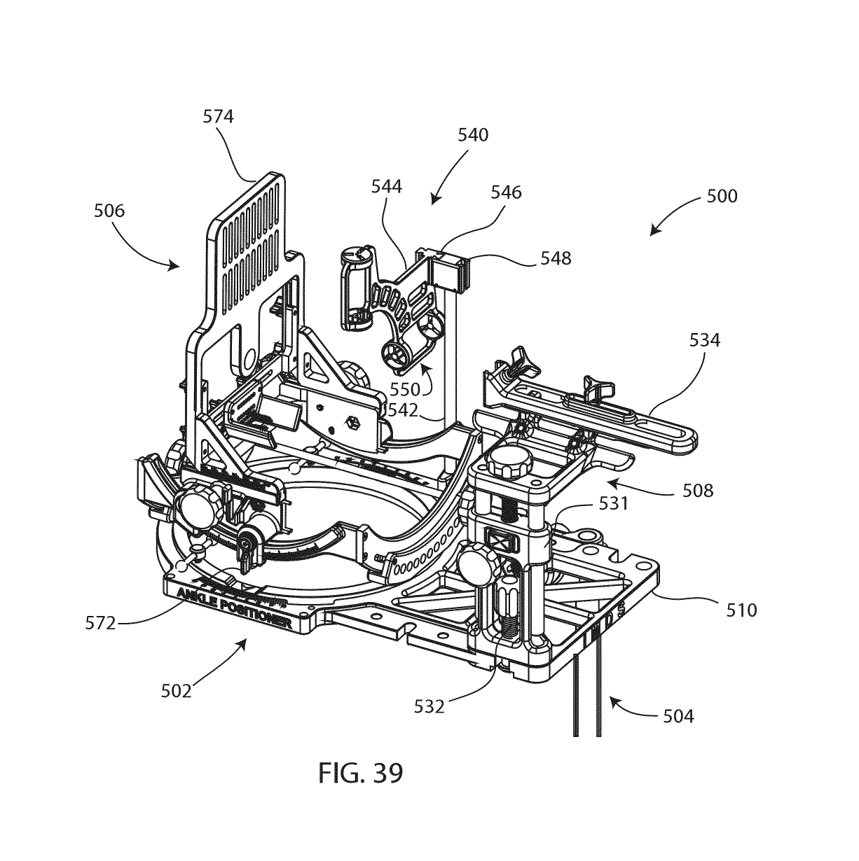

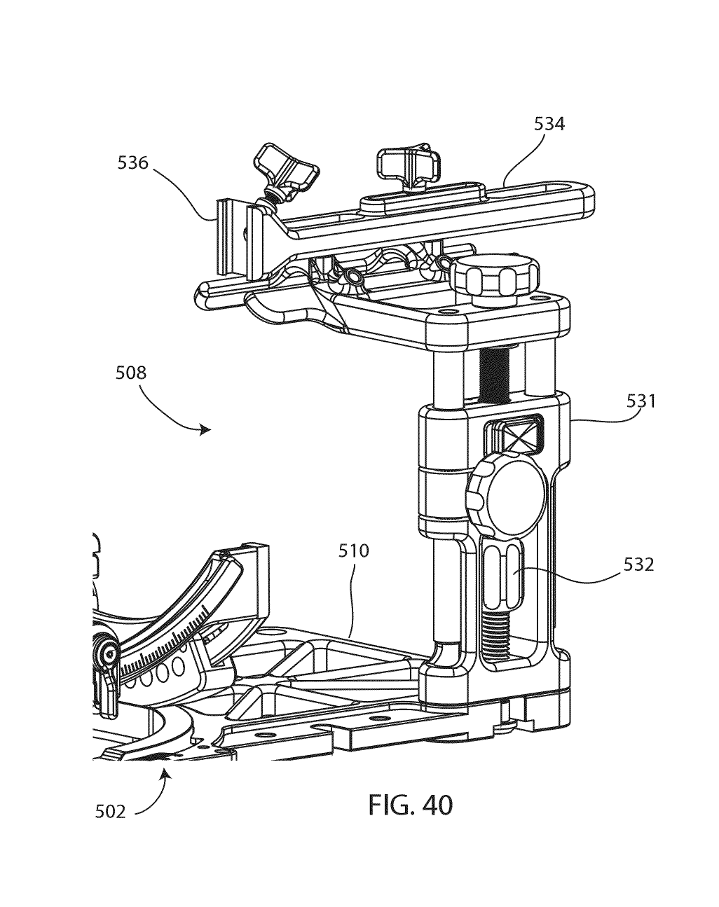

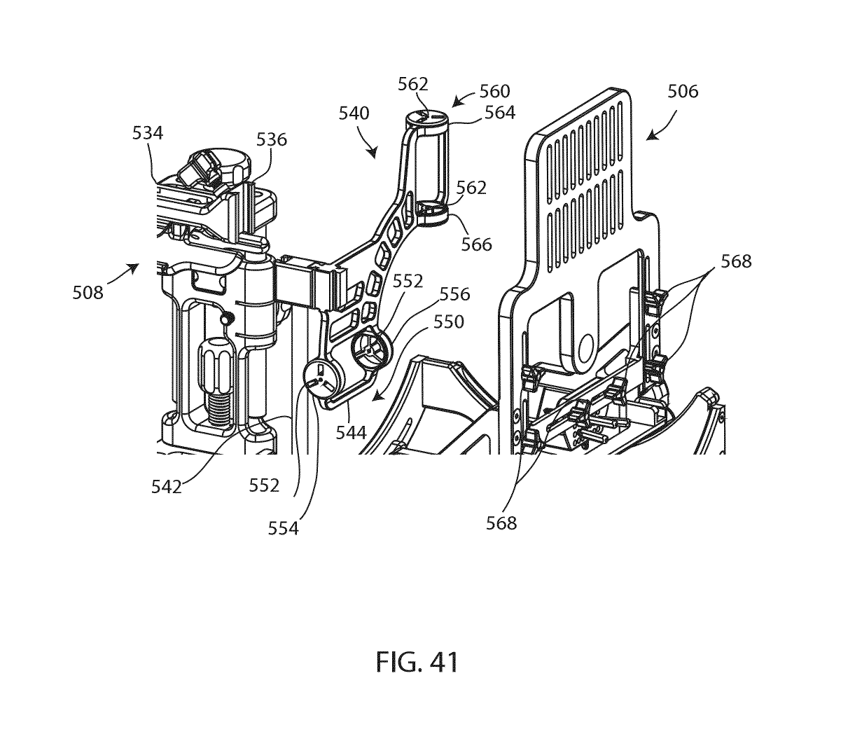

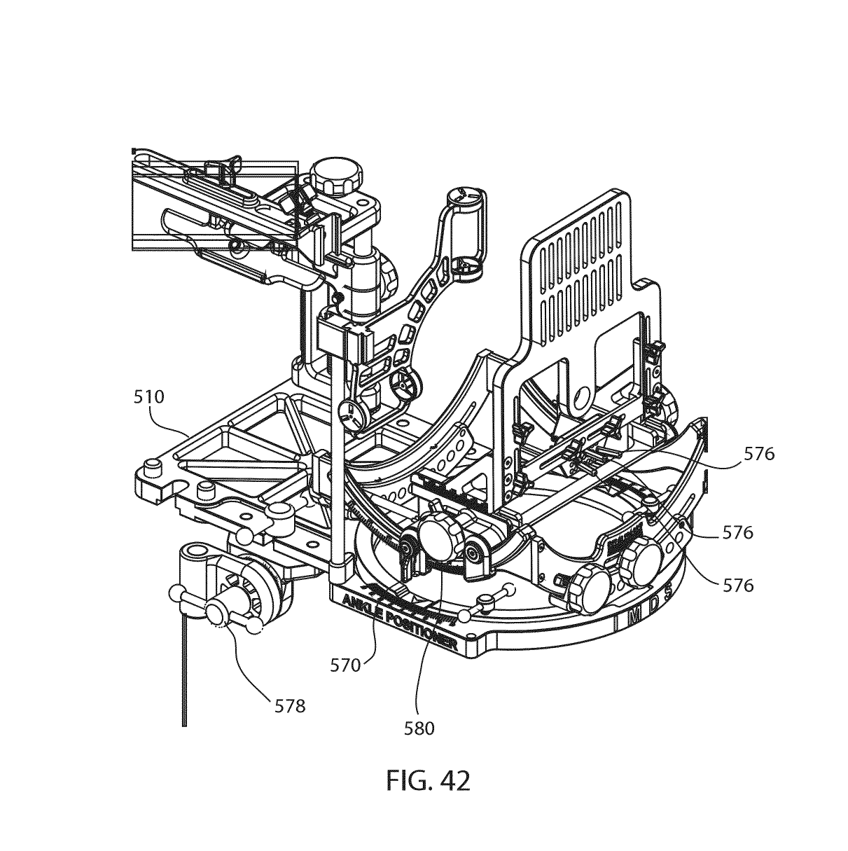

FIGS. 39-42 illustrate another positioning apparatus 500. The positioning apparatus 500 may be placed flat on a support structure such as an examination, surgical, or operating table. Certain fasteners are manually operable, requiring no tools for actuation. A targeting apparatus for the tibial intramedullary canal is included. Unless otherwise specified in the following disclosure and in the accompanying FIGS. 39-42, the positioning apparatus 500 may be similar to, or identical to, the positioning apparatus 100.

The positioning apparatus 500 includes a base subassembly 502, a mounting post subassembly 504, a foot plate subassembly 506, and a tibial clamp subassembly 508. Other subassemblies, accessories, or attachments may be included; some examples will be disclosed below.

The tibial clamp subassembly 508 differs from the tibial clamp subassembly 108 in at least two characteristics. The mounting screw 532 has been relocated from under the base plate (thumbscrew 332, FIG. 21C) to inside the tibial clamp base 531. This difference permits the positioning apparatus 500 to be placed flat on a support structure. The tibial clamp subassembly 508 includes a sliding interface plate 534 which includes a dovetail feature 536 that receives various procedure-specific attachments, such as cutting guides. The sliding interface plate 534 slides in the superior-inferior direction so that attachments may be located directly over the ankle joint or elsewhere along the tibia and/or foot. The dovetail feature 536 provides anterior-posterior adjustability of the attachments so that the attachments are properly positioned relative to the limb, for example, in direct contact with the limb.

The positioning apparatus 500 includes a targeting system 540 which differs from the targeting system of positioning apparatus 100. The positioning apparatus 500 includes a targeting guide or sight 544 which may be positioned directly in line with the central canal of the tibia 2. The targeting system 540 of positioning apparatus 500 is adapted for use with direct imaging (as per positioning apparatus 100) or laser targeting systems on external equipment such as fluoroscopy units, C-arms, and the like, and is easily applied to and removed from the positioning apparatus 500. The targeting system 540 of positioning apparatus 500 is also compact in size. The targeting system 540 of positioning apparatus 500 provides both anterior-posterior and medial-lateral targeting views.

The targeting system includes a mounting post 542 and a targeting sight 544. The mounting post 542 is placed in holes in the base plate 510 and may stay in place throughout the procedure. The mounting post 542 may mount on either the left or right side of the base plate 510. The targeting sight 544 attaches to the mounting post 542 by means of a dovetail interface 546. The targeting sight 544 may mount to either the inferior dovetail interface 546 or a superior dovetail interface 548. The targeting sight 544 is shown coupled to the inferior dovetail interface 546 in FIG. 39. The inferior side places the targeting sight 544 closer to the ankle joint, while the superior side is more closely aligned with the tibial central canal. The targeting system includes a lateral alignment aid 550 which is similar to lateral alignment aid 246, and includes a central aperture 552 through both portions 554, 556 of the lateral alignment aid 550 to permit laser alignment. The targeting system includes an anterior alignment aid 560 which is similar to lateral alignment aid 550, and includes a central aperture 562 through both portions 564, 566 of the anterior alignment aid 560 to permit laser alignment. The targeting system 540 may be used to properly register the C-arm to the limb for accurate imaging. The step of positioning the limb in the general positioning apparatus 500 may be performed as described above for positioning apparatus 100.

The positioning apparatus 500 includes larger diameter knobs and thumbscrews compared to those shown in positioning apparatus 100. In particular, larger knobs 580 are included for the foot plate rack and pinion gear so that larger distraction forces may be applied ergonomically without requiring the use of tools. The table clamp screw head 578 (tilt axis screw only) is longer, to minimize risk of collision with the clamp body. The fasteners 312 have been replaced with thumbscrews 568. The orientation of the trolley position locking levers 570, 572 (comparable to latches 298, 300) is vertical to be gravitationally neutral. The foot plate 574 is smaller than the foot plate 304. Self-drilling and self-tapping heel (calcaneal) screws 576 are included with the positioning apparatus 500. The screws 576 include polyaxial heads to permit the screws to engage the corresponding holes at various angles.

The present invention may be embodied in other specific forms without departing from its spirit or essential characteristics. It is appreciated that various features of the above-described examples can be mixed and matched to form a variety of other alternatives. As such, the described embodiments are to be considered in all respects only as illustrative and not restrictive.

It should be understood that the present system, kits, apparatuses, and methods are not intended to be limited to the particular forms disclosed. Rather, they are to cover all modifications, equivalents, and alternatives falling within the scope of the claims.

The claims are not to be interpreted as including means-plus- or step-plus-function limitations, unless such a limitation is explicitly recited in a given claim using the phrase(s) “means for” or “step for,” respectively.

The term “coupled” is defined as connected, although not necessarily directly, and not necessarily mechanically.

The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited topossessing only those one or more features. Furthermore, a device or structure that is configured in a certain way is configured in at least that way, but may also be configured in ways that are not listed.

1. A limb positioning system comprising:
a base subassembly comprising a base plate, an inner ring, a gimbal, and a trolley;
wherein the base plate comprises a length, a width perpendicular to the length of the base plate, and an outer ring with a center point;
wherein the inner ring is rotatably coupled to the outer ring, wherein the inner ring comprises a center point in common with the center point of the outer ring, wherein the inner ring rotates relative to the outer ring about a first axis extending along the common center points of the inner ring and the outer ring;
wherein the gimbal is rotatably coupled to the inner ring, wherein the gimbal comprises a length, a width perpendicular to the length of the gimbal, bilateral arcuate slots spaced along the length of the gimbal, and bilateral arcuate grooves spaced across the width of the gimbal, wherein the bilateral arcuate slots comprise a common cylindrical surface which extends along the length of the gimbal, wherein the bilateral arcuate grooves comprise a common cylindrical surface which extends across the width of the gimbal, wherein the gimbal rotates relative to the inner ring about a second axis extending along a center of the cylindrical surface of the bilateral arcuate slots;
wherein the trolley is rotatably coupled to the gimbal, wherein the trolley comprises a length, a width perpendicular to the length of the trolley, bilateral rollers spaced across the width of the trolley, and bilateral linear grooves spaced across the width of the trolley, wherein the trolley rotates relative to the gimbal about a third axis extending along a center of the cylindrical surface of the bilateral arcuate grooves; and
a plate subassembly removably coupled to the base subassembly, wherein the plate subassembly comprises a length, a width perpendicular to the length of the plate subassembly, and bilateral linear rails spaced across the width of the plate subassembly, wherein the plate subassembly slides relative to the trolley along a fourth axis extending parallel to the bilateral linear grooves.

2. A system comprising:
a base subassembly comprising a first joint, a second joint, and a third joint;
a plate subassembly removably coupled to the base subassembly by a fourth joint; and
a limb clamp subassembly removably coupled to the base subassembly.
